(19) United States
(12) Patent Application Publication
(10) Pub. No.: US 2024/0111307 A1
(43) Pub. Date: Apr. 4, 2024

(54) MOVEMENT CONTROL SYSTEM, MOVEMENT CONTROL APPARATUS, AND MOVEMENT CONTROL METHOD

(71) Applicant: NEC Corporation, Minato-ku, Tokyo (JP)

(72) Inventor: Taichi Kumagai, Tokyo (JP)

(73) Assignee: NEC Corporation, Minato-ku, Tokyo (JP)

(21) Appl. No.: 18/273,675

(22) PCT Filed: Feb. 17, 2021
(86) PCT No.: PCT/JP2021/005972

§ 371 Date: Jul. 21, 2023

(51) Int. Cl. G05D 1/622; G05D 1/646; G05D 1/69

(52) U.S. Cl. CPC G05D 1/622; G05D 1/646; G05D 1/69; G05D 2105/20

(57) ABSTRACT

A movement control system (1000) includes at least one moving body (1), a sensor (3) configured to transmit movement region information related to a movement region of the moving body, a route generating unit (440) configured to generate a route for the moving body to move through the movement region, based on the movement region information received via a network, and a moving body control unit (450) configured to control movement of the moving body, based on the route. The route generating unit is configured to generate an avoidance route for avoiding a second region including a first region representing a position of an object existing in the movement region and a surrounding region at the first region. The moving body control unit is configured to control the moving body based on the avoidance route.

### TECHNICAL FIELD

The present invention relates to a movement control system, a movement control apparatus, and a movement control method.

### BACKGROUND ART

In distribution warehouses, factories, and the like, robots (moving bodies) for transporting components, materials, and the like have hitherto been utilized. For example, PTL 1 discloses a technique of detecting an obstruction present around a robot by using a sensor mounted on the robot, and generating a movement route so that the detected obstruction is avoided, to move the robot. PTL 2 discloses a technique of controlling a posture of a robot based on a distance between an obstruction detected by a sensor and the robot, to move the robot along a movement route.

### CITATION LIST

### Patent Literature

[PTL 1] JP 2020-004095 A
[PTL 2] JP 2010-055415 A

### SUMMARY

### Technical Problem

In the techniques disclosed in PTLs 1 and 2, a robot is controlled based on signals of a sensor mounted on the robot itself. In order to avoid an obstruction such as a component and a material using the techniques disclosed in PTLs 1 and 2, the robot needs to be moved to a range in which the sensor is able to detect the obstruction, which may bring the robot too close to the obstruction. As a result, with the robot coming closer to the obstruction, the robot may fail to transport a transport object safely. For example, when the robot performs avoidance operation right in front of the obstruction and the obstruction is moved, collision with the robot may not be fully avoided. Also, when the robot fails to operate in accordance with a control input due to malfunction or the like, for example, it is assumed that the obstruction and the robot collide with each other. In this manner, an issue is that safety and efficiency of transport operation are reduced, when the robot comes too close to the obstruction.

An example object of the present invention is to provide a movement control system, a movement control apparatus, and a movement control method for enhancing safety and efficiency of transport operation.

### Solution to Problem

A movement control system according to the present invention includes at least one moving body, a sensor configured to transmit movement region information related to a movement region of the moving body, a route generating unit configured to generate a route for the moving body to move through the movement region, based on the movement region information received via a network, and a moving body control unit configured to control movement of the moving body, based on the route. The route generating unit is configured to generate an avoidance route for avoiding a second region including a first region representing a position of an object existing in the movement region and a surrounding region at the first region. The moving body control unit is configured to control the moving body based on the avoidance route.

A movement control apparatus according to the present invention includes a route generating unit configured to generate, based on movement region information related to a movement region of at least one moving body received from a sensor via a network, a route for the moving body to move through the movement region, and a moving body control unit configured to control movement of the moving body, based on the route. The route generating unit is configured to generate an avoidance route for avoiding a second region including a first region representing a position of an object existing in the movement region and a surrounding region at the first region. The moving body control unit is configured to control the moving body based on the avoidance route.

A movement control method according to the present invention includes transmitting movement region information related to a movement region of at least one moving body, generating a route for the moving body to move through the movement region, based on the movement region information received via a network, and controlling movement of the moving body, based on the route. In generating the route, an avoidance route for avoiding a second region including a first region representing a position of an object existing in the movement region and a surrounding region at the first region is generated. In controlling the movement of the moving body, the moving body is controlled based on the avoidance route.

### Advantageous Effects of Invention

According to the present invention, the moving body is moved while avoiding an obstruction such that the moving body does not come too close to the obstruction. Therefore, the movement control system, the movement control apparatus, and the movement control method for enhancing safety and efficiency of transport operation can be provided. Note that, according to the present invention, instead of or together with the above effects, other effects may be exerted.

### BRIEF DESCRIPTION OF THE DRAWINGS

FIG. 1 is a diagram illustrating an overview of a transport system according to a first example embodiment;

FIG. 2 is a diagram illustrating a hardware configuration of an information processing apparatus according to the first example embodiment;

FIG. 3 is an external perspective view illustrating a schematic configuration of a transport robot according to the first example embodiment;

FIG. 4 is a top view illustrating operations of a pivoting mechanism, a restoration mechanism, and a guide mechanism of the transport robot according to the first example embodiment;

FIG. 5 is a functional block diagram illustrating a functional configuration of the transport robot according to the first example embodiment;

FIG. 6 is a schematic diagram illustrating an example of a route on which the transport robot moves according to the first example embodiment;

FIG. 7 is an explanatory diagram for illustrating control of the transport robot according to the first example embodiment;

FIG. 8 is a block diagram illustrating an example of a schematic configuration of a movement control system according to the first example embodiment;

FIG. 9 is a functional block diagram illustrating an example of a schematic configuration of a movement control apparatus according to the first example embodiment;

FIG. 10 is a sequence diagram illustrating a flow of controlling movement of a moving body in the movement control system according to the first example embodiment;

FIG. 11 is a flowchart illustrating a flow of controlling movement of the moving body in a movement control method according to the first example embodiment;

FIG. 12 is an explanatory diagram of a first region and a second region according to the first example embodiment;

FIG. 13 is a diagram illustrating an operation mode of a transport system according to a second example embodiment;

FIG. 14 is a sequence diagram illustrating a flow of controlling movement of the transport robot in the transport system according to the second example embodiment;

FIG. 15 is a diagram illustrating an operation mode of a transport system according to a third example embodiment;

FIG. 16 is an explanatory diagram of an avoidance route according to the third example embodiment;

FIG. 17 is a sequence diagram illustrating a flow of controlling movement of the transport robot in the transport system according to the third example embodiment;

FIG. 18 is an explanatory diagram of position information according to the third example embodiment;

FIG. 19 is a diagram illustrating an example of an information configuration of the position information according to the third example embodiment;

FIG. 20 is a diagram illustrating an example of an information configuration of moving body information related to moving bodies according to the third example embodiment;

FIG. 21 is a diagram illustrating an example of an information configuration of transport object information related to a transport object according to the third example embodiment;

FIG. 22 is a diagram illustrating an operation mode of a transport system according to a fourth example embodiment;

FIG. 23 is a sequence diagram illustrating a flow of controlling movement of transport robots in the transport system according to the fourth example embodiment;

FIG. 24 is a plan view schematically illustrating an example of cooperative transport according to the fourth example embodiment;

FIG. 25 is a side view schematically illustrating an example of cooperative transport according to the fourth example embodiment;

FIG. 26 is an explanatory diagram of an avoidance route according to the fourth example embodiment; and

FIG. 27 is a general view of a movement region according to the fourth example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Each example embodiment described below is merely an example of a configuration that can implement the present invention. Each example embodiment described below can be appropriately modified or changed according to a configuration of an apparatus to which the present invention is applied and various conditions. All of combinations of elements included in each example embodiment described below are not necessarily required to implement the present invention, and a part of the elements can be appropriately omitted. Hence, the scope of the present invention is not limited by the configuration described in each example embodiment described below. Configurations in which a plurality of configurations described in the example embodiments are combined can also be adopted unless the configurations are consistent with each other.

Descriptions will be given in the following order.
1. Overview of Example Embodiments of Present Invention
2. First Example Embodiment
   2.1. Overview of Transport System
   2.2. Hardware Configuration of Information Processing Apparatus
   2.3. Overview of Transport Robot
   2.4. Operation Mode of Transport System
   2.5. Flow of Processing in Transport System
3. Second Example Embodiment
   3.1. Operation Mode of Transport System
   3.2. Flow of Processing in Transport System
4. Third Example Embodiment
   4.1. Operation Mode of Transport System
   4.2. Method of Generating Avoidance Route
   4.3. Flow of Processing in Transport System
5. Fourth Example Embodiment
   5.1. Operation Mode of Transport System
   5.2. Method of Generating Avoidance Route
   5.3. Flow of Processing in Transport System
6. Example Alteration of Fourth Example Embodiment
7. Other Example Embodiments

### 1. OVERVIEW OF EXAMPLE EMBODIMENTS OF PRESENT INVENTION

First, an overview of example embodiments of the present invention will be described.

### Technical Issue

In distribution warehouses, factories, and the like, robots (moving bodies) for transporting components, materials, and the like have hitherto been utilized. For example, disclosed is a technique of detecting an obstruction present around a robot by using a sensor mounted on the robot, and generating a route so that the detected obstruction is avoided, to move the robot. In addition, disclosed is a technique of controlling a posture of a robot based on a distance between an obstruction detected by a sensor and the robot, to move the robot along a route.

In these techniques, a robot is controlled based on signals of a sensor mounted on the robot itself. In order to avoid an obstruction such as a component and a material using these techniques, the robot needs to be moved to a range in which the sensor is able to detect the obstruction, which may bring the robot too close to the obstruction. As a result, with the robot coming closer to the obstruction, the robot may fail to transport a transport object safely. For example, when the robot performs avoidance operation right in front of the obstruction and the obstruction is moved, collision with the robot may not be fully avoided. Also, when the robot fails to operate in accordance with a control input due to malfunction or the like, for example, it is assumed that the obstruction and the robot collide with each other. In this manner, an issue is that safety and efficiency of transport operation are reduced, when the robot comes too close to the obstruction.

In view of the circumstances described above, the present invention has an example object to provide a movement control system, a movement control apparatus, and a movement control method for enhancing safety and efficiency of transport operation.

### 2. FIRST EXAMPLE EMBODIMENT

<2.1. Overview of Transport System>

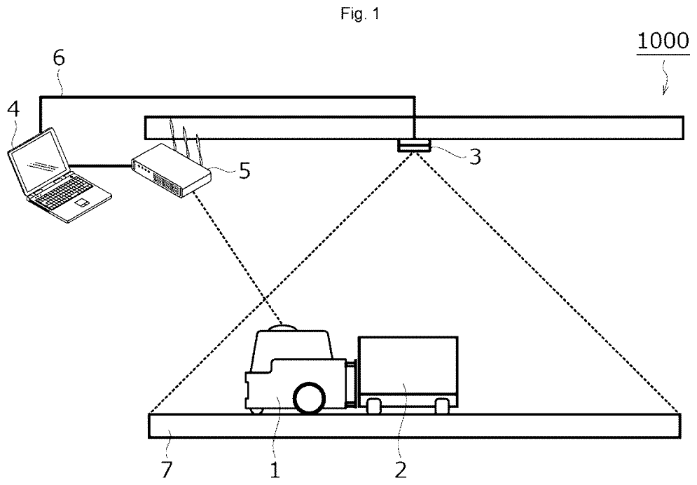

First, with reference to FIG. 1, an overview of a transport system 1000 according to a first example embodiment of the present invention will be described. FIG. 1 is a diagram illustrating an overview of the transport system 1000. The transport system 1000 includes a transport robot 1, a transport object 2, a sensor 3, a system control apparatus 4, and an access point (AP) 5, which are connected via a network 6. Note that the transport system 1000 may include transport robots other than the transport robot 1. The transport system 1000 need not include the AP 5. Moreover, the transport system 1000 may include a plurality of sensors 3 and APs 5. As the network 6, only radio communication, such as Wifi, local 5G, 4G, 3G, and LTE, may be used, or a combination of radio communication and wired communication may be used.

As illustrated in FIG. 1, the transport robot 1 can transport the transport object 2 as an object to be transported. As the transport robot 1, for example, a transport robot that can move while carrying the transport object 2, a transport robot that can move while pulling a cart carrying the transport object 2 with a pulling tool, a transport robot that can move while supporting the transport object 2, a transport robot that can move while lifting a cart carrying the transport object 2, and the like may be used. Note that the transport robot 1 of the present disclosure is an example of the moving body.

The sensor 3 acquires information related to a movement region in the movement region through which the transport robot 1 moves. Note that the movement region corresponds to a region in which the transport robot included in the transport system 1000 can travel. The information related to the movement region is, for example, information corresponding to an image of the movement region, absolute coordinates of an obstruction 7 in the movement region, relative coordinates thereof (with respect to the current position and a destination of the transport robot 1), an identification number of an area in the movement region in which the obstruction 7 exists, and the like. Note that a region specified by a user of the transport system 1000 in advance may be used as the movement region. Information indicating the movement region may be acquired from a database that manages facility information. The information indicating the movement region may be acquired in advance, using a technology such as visual simultaneous localization and mapping (VSLAM). The movement region may be a region including a traveling route specified with a magnetic tape or the like and a surrounding region thereof.

As the sensor 3, for example, a depth camera, a stereo camera, a ToF camera, a laser sensor, a radar sensor, and the like may be used. As illustrated in FIG. 1, the sensor 3 may be disposed above the transport robot 1, and the information related to the movement region may be acquired from above the transport robot 1. For example, when the movement region of the transport robot 1 is present in a factory, a warehouse, or the like, the sensor 3 may be disposed on a roof, a pillar, a beam, or the like of the factory, the warehouse, or the like. With this configuration, the information related to the movement region in a bird's-eye view on the movement region can be acquired. The sensor 3 is connected to the system control apparatus 4 via the network 6, and acquires the information related to the movement region and transmits the information to the system control apparatus 4 as movement region information.

The system control apparatus 4 controls transport operation of the transport robot 1, based on the movement region information received from the sensor 3. First, the system control apparatus 4 generates various pieces of information for controlling the transport operation in the transport system 1000, based on the movement region information. Subsequently, the system control apparatus 4 transmits the pieces of information for controlling the operation of the transport robot 1 to the transport robot 1 via the AP 5. The AP 5 performs radio communication with the transport robot 1. Note that, as a configuration for controlling the transport operation in the transport system 1000, elements corresponding to the system control apparatus 4 may be implemented in a personal computer (PC) or on a cloud. The elements included in the system control apparatus 4 need not necessarily be implemented in the same information processing apparatus. In other words, the elements included in the system control apparatus 4 may be implemented with distributed processing using a plurality of servers. The system control apparatus 4 of the present example embodiment is an example of the movement control apparatus.

When a depth camera is used as the sensor 3, in the system control apparatus 4, the shape of the object is recognized from an image captured by the depth camera according to the height of the object for a traveling surface of the transport robot 1, and the position and the size of the object existing in the movement region of the transport robot 1 can thereby be determined. In some cases, the system control apparatus 4 recognizes information related to the height of the transport robot 1. In this case, in the system control apparatus 4, processing of extracting a region corresponding to the height of the transport robot 1 from the image captured by the depth camera based on depth information is performed, and the position of the transport robot 1 can thereby be determined. In addition, when the transport robot 1 in a bird's-eye view has a specific shape (for example, a rectangular shape), the shape of the transport robot 1 is recognized from the image captured by the depth camera, and the position of the transport robot 1 can thereby be more accurately specified. Note that the sensor 3 may be a sensor unit that can determine the position and the size of the object existing in the movement region of the transport robot 1 from the image captured by the depth camera. A QR code (registered trademark) attached to the transport robot 1 may be read, such that the transport robot 1 existing in the movement region may be recognized. In addition, an identification number of the transport robot 1 may be transmitted to the system control apparatus 4, such that the transport robot 1 existing in the movement region may be recognized.

<2.2. Hardware Configuration of Information Processing Apparatus>

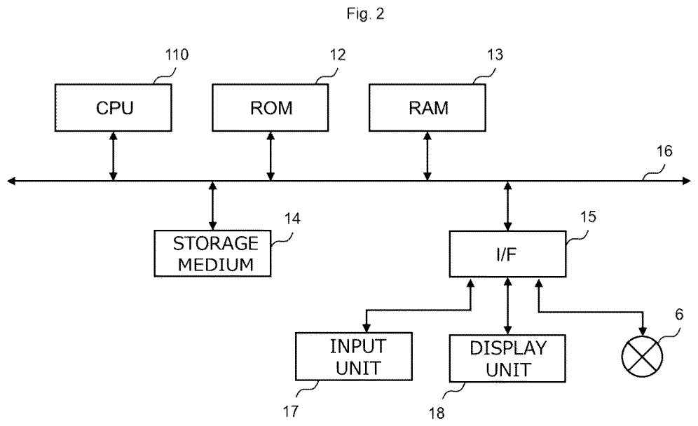

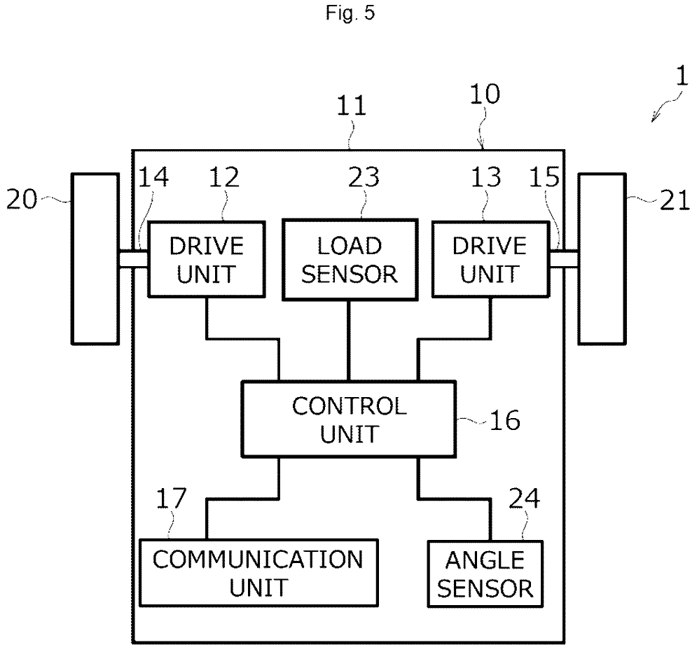

Next, with reference to FIG. 2, a hardware configuration of an information processing apparatus, such as a control unit 16 (see FIG. 5) of the transport robot 1, the system control apparatus 4, and the AP 5, will be described. FIG. 2 is a block diagram illustrating a hardware configuration of the information processing apparatus according to the present example embodiment.

In the information processing apparatus, a central processing unit (CPU) 110, a read only memory (ROM) 120, a random access memory (RAM) 130, a storage medium 140, and an interface (I/F) 150 are connected to each other via a bus 190. An input unit 170, a display unit 180, and the network 6 are connected to the I/F 150.

The CPU 110 is an arithmetic means, and controls operation of the entire information processing apparatus. The RAM 130 is a volatile storage medium capable of rapid reading and writing of information, and is used as a working area when the CPU 110 processes information. The ROM 120 is a read-only non-volatile storage medium, and stores programs such as firmware. The storage medium 140 is a non-volatile storage medium capable of reading and writing of information, such as a hard disk drive (HDD), and stores an OS, various control programs, application programs, and the like.

The I/F 150 connects the bus 190 and various pieces of hardware, the network 6, and the like, and performs control. The input unit 170 is an input apparatus, such as a keyboard and a mouse, for the user to input information to the information processing apparatus. The display unit 180 is a display apparatus, such as a liquid crystal display (LCD), for the user to check a state of the information processing apparatus. Note that the input unit 170 and the display unit 180 may be omitted.

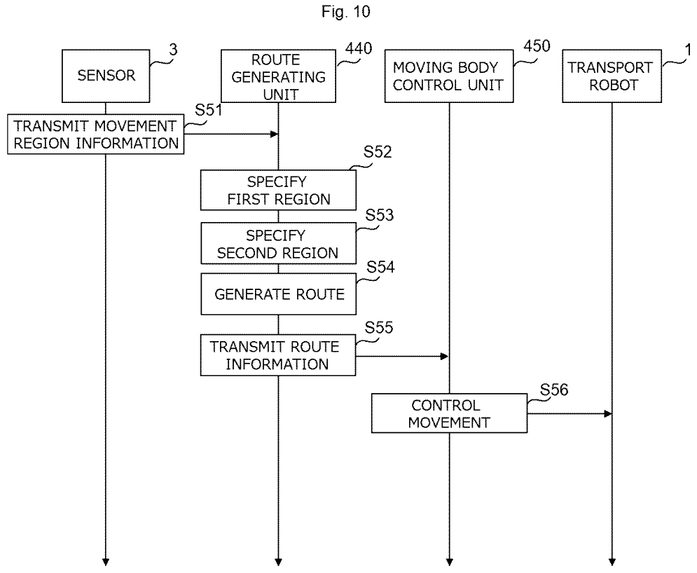

In the hardware configuration as described above, with the CPU 110 performing arithmetic operations in accordance with the programs stored in the ROM 120 and the programs loaded into the RAM 130 from the storage medium 140, a software control unit of the information processing apparatus is configured. Combinations of the software control unit configured as described above and the hardware configure functional blocks for implementing functions of the control unit 16 (see FIG. 5) of the transport robot 1 and the information processing apparatus such as a controller 400 (see FIG. 10) of the system control apparatus 4 according to the present example embodiment.

<2.3. Overview of Transport Robot>

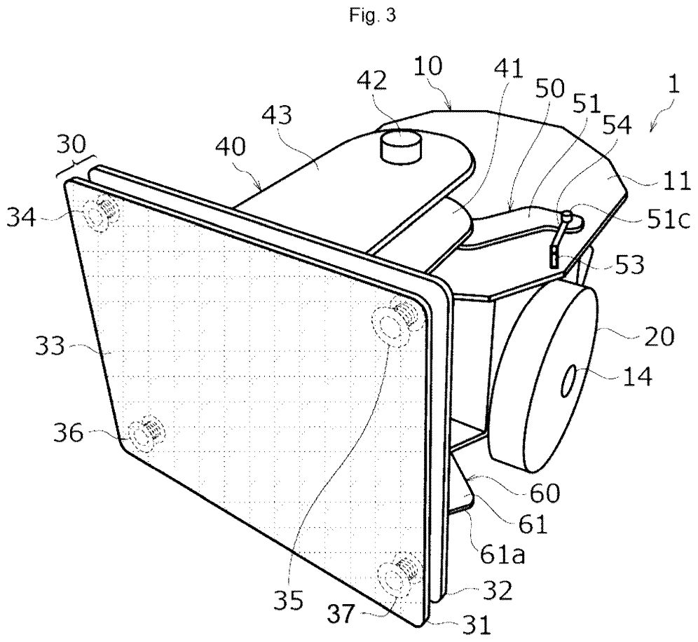

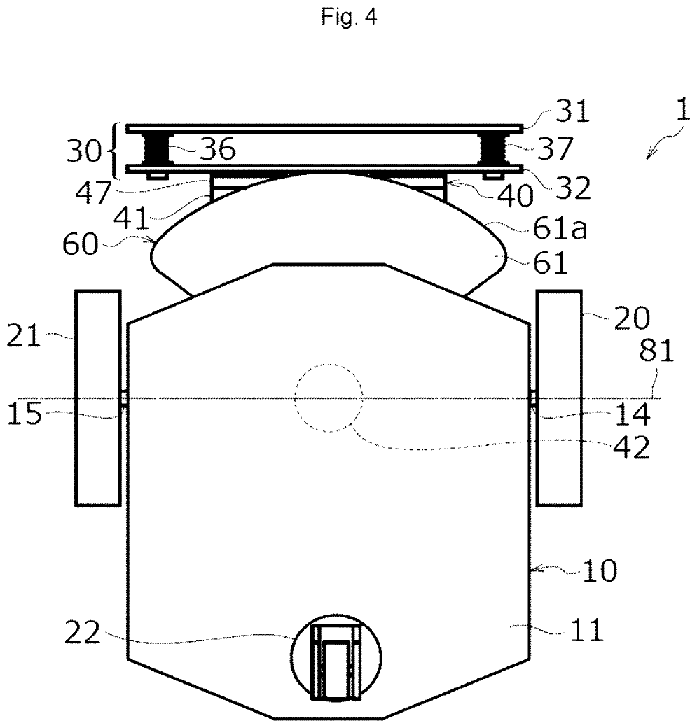

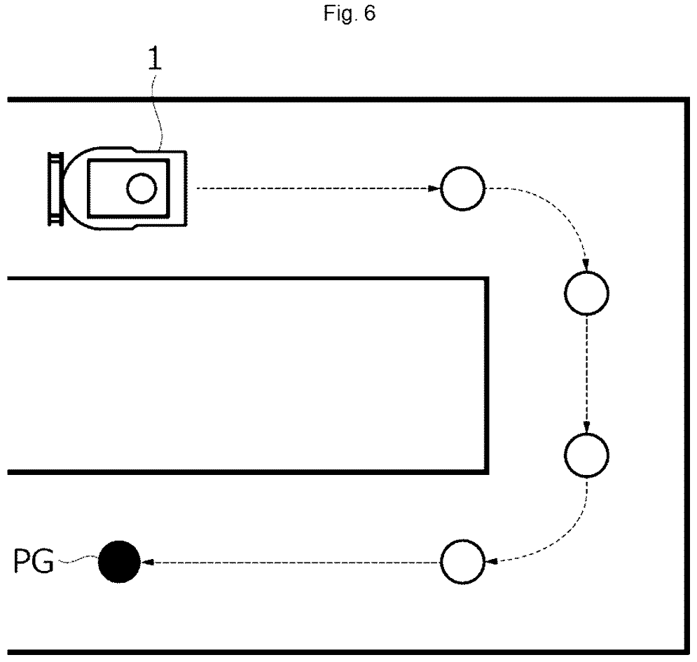

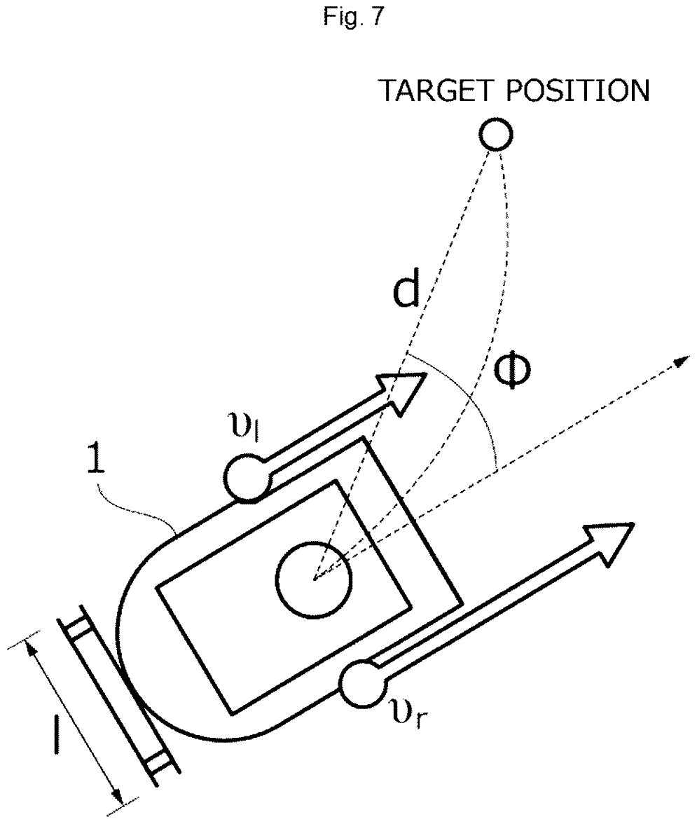

Next, with reference to FIG. 3 to FIG. 7, an overview of the transport robot 1 will be described. FIG. 3 is an external perspective view illustrating a schematic configuration of the transport robot 1. FIG. 4 is a top view illustrating operations of a pivoting mechanism 40, a restoration mechanism 50, and a guide mechanism 60 of the transport robot 1. FIG. 5 is a functional block diagram illustrating a functional configuration of the transport robot 1. FIG. 6 is a schematic diagram illustrating an example of a route of the transport robot 1. FIG. 7 is an explanatory diagram for illustrating control of the transport robot 1.

First, with reference to FIG. 3 and FIG. 4, a schematic configuration of the transport robot 1 will be described. The transport robot 1 includes a main body 10, wheels 20 and 21, a contact part 30, the pivoting mechanism 40, and the guide mechanism 60.

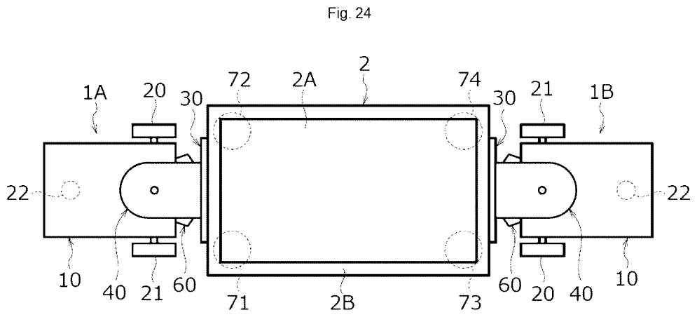

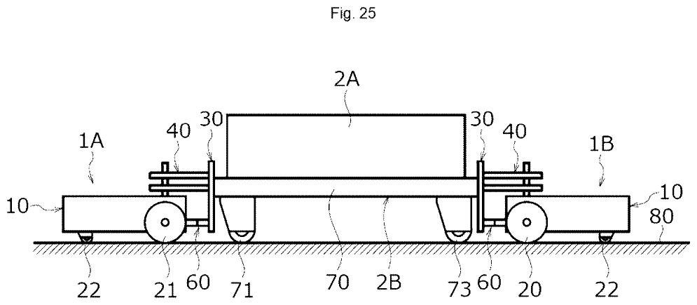

The main body 10 includes a frame 11 to which the wheels 20 and 21, the contact part 30, the pivoting mechanism 40, and the guide mechanism 60 are attached. The wheels 20 and 21 are rotatably attached to both side surfaces of the frame 11. A caster 22 is attached to a bottom surface of the frame 11 (see FIG. 24 and FIG. 25).

The wheel 20 is fixed to a shaft 14. The wheel 21 is fixed to a shaft 15. The wheels 20 and 21 are disposed so as to be concentric on an axle 81. Note that the wheels 20 and 21 may be disposed to have camber angle, or may be designed so that their camber angles vary by a suspension, a constant-velocity joint, or the like.

The caster 22 is freely turnably configured so that its moving direction can be changed in conjunction with rotation of the wheels 20 and 21.

The contact part 30 is a part to come in contact with the transport object 2, and is fixed to one end of each of arms 41 and 43 of the pivoting mechanism 40. The arms 41 and 43 are freely pivotably supported on the frame 11 about a shaft part 42 provided on another end of each of the arms 41 and 43. The contact part 30 is pivotable in conjunction with pivoting of the arms 41 and 43. Note that a pivoting direction of the contact part 30 at least includes a horizontal direction with respect to the main body 10, and may additionally include a vertical direction with respect to the main body 10.

A plate member 31 is supported on a plate member 32, with elastic members 34, 35, 36, and 37 being interposed therebetween. A surface of the plate member 31 to come in contact with the transport object 2 is provided with a friction part 33.

The plate member 32 supports the plate member 31, with the elastic members 34, 35, 36, and 37 being interposed therebetween. The plate member 32 is attached to the arm 43 with a stay, and is attached to the arm 41 with a stay 47. The plate member 32 is slidably disposed while abutting against a guide surface 61a of a guide member 61.

The friction part 33 is provided on a surface of the plate member 31 to come in contact with the transport object 2 in order to increase a frictional force generated against the transport object 2. This can reduce slipping of the transport object 2 even if the pivoting mechanism 40 rotates while abutting against the friction part 33 in the plate member 31. As materials for the friction part 33, for example, a material having a coefficient of friction higher than that of a material used for the plate member 31, or a resilient and elastic material (for example, rubber) may be used.

Each of the elastic members 34, 35, 36, and 37 is disposed between the plate member 31 and the plate member 32. Each of the elastic members 34, 35, 36, and 37 is an elastic member, such as a coil spring, that is elastically deformed according to an interval between the plate members 31 and 32. Note that a spring coefficient of each of the elastic members 34, 35, 36, and 37 can be used for detection of a load by a load sensor 23 (see FIG. 5) to be described later.

The pivoting mechanism 40 freely pivotably supports the contact part 30 on the main body 10. The pivoting mechanism 40 includes the shaft part 42 and the arms 41 and 43.

The shaft part 42 is attached to an upper surface of the frame 11. It is preferable that the shaft center of the shaft part 42 be designed to pass through the midpoint of a width W between the wheels 20 and 21. The arms 41 and 43 are pivotably attached to the shaft part 42.

The arms 41 and 43 are disposed on the main body 10 so as to have a predetermined interval in the vertical direction, and are formed into such a shape that the contact part 30 does not come in contact with the main body 10 and the wheels 20 and 21 when the contact part 30 is pivoted. The arm 43 is attached to the plate member 31 of the contact part 30 with the stay (not illustrated). The arm 41 is attached to the plate member 31 of the contact part 30 with the stay 47. FIG. 3 illustrates an example of the pivoting mechanism 40 including two arms 41 and 43; however, the pivoting mechanism 40 may include one arm, or three or more arms.

Pin parts (not illustrated) are fixed to the arm 41, at positions radially away from the shaft part 42. The pin parts of the arm 41 are away from each other, and an oscillation member 51 of the restoration mechanism 50 is disposed at a position that may come in contact with the pin parts of the arm 41.

The restoration mechanism 50 pivots the pivoting mechanism 40 so as to restore the contact part 30 that has been pivoted from a predetermined position back to the predetermined position. The restoration mechanism 50 includes the oscillation member 51, a shaft part (not illustrated), a pin part 53, and an elastic member 54.

The oscillation member 51 is oscillatably provided about a shaft part (not illustrated) attached to the frame 11, at a position different from the shaft part 42. The oscillation member 51 can oscillate while being in contact with the pin parts (not illustrated) provided in the arm 41. A pin part 51c is provided on the oscillation member 51 at one end, so as to be drawn toward the pin part 53 connected to the elastic member 54 at another end.

The pin part 51c of the oscillation member 51 is attached to the elastic member 54 at one end and a pin part (not illustrated) is attached thereto at another end, and the pin part 51c of the oscillation member 51 is elastically deformed so as to be drawn toward the pin part 53. When the oscillation member 51 oscillates while the oscillation member 51 and the pin parts (not illustrated) provided on the arm 41 come in contact with each other, the elastic member 54 is elastically deformed. As the elastic member 54, for example, a coil spring, a torsion spring, or the like may be used.

In the restoration mechanism 50, the oscillation member 51 is pivoted about the shaft part (not illustrated) when the arm 41 is pivoted about the shaft part 42 from a predetermined position (center position) toward the left side, and this extends the elastic member 54 between the pin parts 51c and 53. The arm 41 is pivoted to be restored back to the predetermined position (center position) with a force of compression of the elastic member 54.

In the restoration mechanism 50, the oscillation member 51 is pivoted about the shaft part (not illustrated) when the arm 41 is pivoted about the shaft part 42 from a predetermined position (center position) toward the right side, and this extends the elastic member 54 between the pin parts 51c and 53. The arm 41 is pivoted to be restored back to the predetermined position (center position) with a force of compression of the elastic member 54.

Note that the pivoting mechanism 40 may include an attenuation mechanism of attenuating vibration generated due to extension and compression of the elastic member 54 by employing friction, viscosity, hysteresis, or the like.

The guide mechanism 60 includes the guide member 61, and guides the main body 10 from the contact part 30. The guide member 61 includes the guide surface 61a formed along the course of the pivot of the contact part 30, and the plate member 32 is slidably disposed along the guide surface 61a.

FIG. 5 is a diagram illustrating a functional configuration of the transport robot 1 mounted in an internal space of the frame 11. The transport robot 1 includes drive units 12 and 13, the shafts 14 and 15, the control unit 16, a communication unit 17, the load sensor 23, and an angle sensor 24.

The drive units 12 and 13 correspond to a driving unit including a motor, a speed reducer, a driver, various types of sensors (a current sensor, a torque sensor, a position sensor, and the like), a regulator, or the like, and drive the wheels 20 and 21, respectively.

The shafts 14 and 15 are shaft members that transmit rotation power of the drive units 12 and 13 to the wheels 20 and 21, respectively. The shaft 14 is connected to an output shaft of the drive unit 12, extends toward one side surface outside of the frame 11, and is connected to a shaft of the wheel 20 outside of the frame 11. The shaft 15 is connected to an output shaft of the drive unit 13, extends toward another side surface outside of the frame 11, and is connected to a shaft of the wheel 21 outside of the frame 11. The shafts 14 and 15 are disposed so as to be concentric with each other on the axle 81 indicated by a one dot chain line in FIG. 4. Note that the shafts 14 and 15 may be disposed so that the wheels 20 and 21 are inclined with respect to the frame 11. The shafts 14 and 15 may be designed so that inclinations of the wheels 20 and 21 vary by a suspension, a constant-velocity joint, or the like.

The control unit 16 includes the CPU 110, the ROM 120, the RAM 130, and the like, and controls the drive units 12 and 13. The control unit 16 controls the drive units 12 and 13, in such a manner that a moving velocity, a moving direction, and driving torque of the transport robot 1 are adjusted. The control unit 16 can communicate with another transport robot and the information processing apparatus such as the system control apparatus 4 included in the transport system 1000 via the communication unit 17. The control unit 16 controls operations of the transport robot 1, based on control information received from the system control apparatus 4. Note that the control information of the transport robot 1 in the present disclosure refers to information for controlling operations of the transport robot 1, such as start and stop of movement of the transport robot 1. The control information of the transport robot 1 may include, for example, a rotational velocity of the wheels 20 and 21, position information of the transport robot 1, information of a route on which the transport robot 1 moves, and the like.

The control unit 16 receives detection results of a load of the transport object 2 detected by the load sensor 23, and controls the drive units 12 and 13, based on the received detection results.

The load sensor 23 is a sensor that detects a load applied to the contact part 30. As the load sensor 23, for example, a distance sensor that can detect the load applied to the contact part 30 based on a distance between the plate member 31 and the plate member 32 interposing the elastic members 34, 35, 36, and 37 in the contact part 30 may be used. As the load sensor 23, a piezoelectric element, a strain gauge, or the like that detects a pressure that the plate member 31 receives from the transport object 2 may be used. The detection results of the load sensor 23 are transmitted to the control unit 16.

The angle sensor 24 is a sensor that detects a rotating angle of the arms 41 and 43. As described above, the contact part 30 is also pivoted in conjunction with pivoting of the arms 41 and 43, and thus a pivoting angle of the arms 41 and 43 corresponds to a pivoting angle of the contact part 30. As the angle sensor 24, for example, a position encoder for angle measurement or a position angle sensor (of a magnetic type, a resolver type, a contact type) connected to a part of the shaft part 42 pivoting in conjunction with the arms 41 and 43 or the like may be used. The detection results of the angle sensor 24 are transmitted to the control unit 16.

The control unit 16 receives the detection results of the rotating angle of the contact part 30 detected by the angle sensor 24, and controls the drive units 12 and 13, based on the received detection results.

The communication unit 17 communicates with moving bodies other than the transport robot 1 included in the transport system 1000, and an external input apparatus such as a tablet terminal and a portable communication terminal operated by an operator of the transport system 1000.

FIG. 6 is a diagram illustrating an example of a route on which the transport robot 1 moves. The figure illustrates an example of the route on which the transport robot 1 moves, with predicted points of passage of the transport robot 1 being denoted by circles and the circles being connected with a line. The transport robot 1 can move in accordance with an instruction from the external input apparatus operated by the operator of the transport system 1000, for example. For example, when information specifying a starting point PS of movement of the transport robot 1 and an end point PG of movement of the transport robot 1 is received from the external input apparatus, as illustrated in FIG. 6, a movement is made along a route connecting the starting point PS and the end point PG. Note that the starting point PS is the current position of the transport robot 1, and may be calculated based on information acquired from the sensor 3 via the communication unit 17, or may be calculated based on a control history of the drive units 12 and 13. For example, the transport robot 1A may be provided with a position detection unit such as a Global Positioning System (GPS) receiver and a beacon receiver, so as to acquire the current position of the transport robot 1.

Next, with reference to FIG. 7, control information transmitted to the transport robot 1 from the system control apparatus 4 will be described. FIG. 7 is an explanatory diagram for illustrating operation of the transport robot 1 when the transport robot 1 moves to the end point PG through arc motion. FIG. 7 illustrates operation of the transport robot 1 when the drive unit 12 moves at a velocity vl and the drive unit 13 moves at a velocity vr, on an assumption that the transport robot 1 moves by a distance d in a period of time Δt.

On an assumption that the transport robot 1 moves by the distance d in the period of time Δt, the velocity yr of the wheel 20 and the velocity vi of the wheel 21 of the transport robot 1 can be calculated based on Expression (1-1).

$$\begin{matrix}[ Math . 1 ] & \\ {v}_{r , l} = \frac{Φ}{Δ t} ( \frac{d}{sin Φ} \pm l ) & Expression ( 1 - 1 )\end{matrix}$$

In Expression (1-1), “Φ” corresponds to an angle between a line connecting a point away from the transport robot 1 by the distance d and the transport robot 1 and an imaginary line indicating a moving direction of the transport robot 1.

When the transport robot 1 independently transports the transport object 2, the velocity yr of the drive unit 12 and the velocity vl of the drive unit 13 of the transport robot 1, which can be calculated based on Expression (1-1), are transmitted from the system control apparatus 4 to the transport robot 1 as the control information.

<2.4. Operation Mode of Transport System>

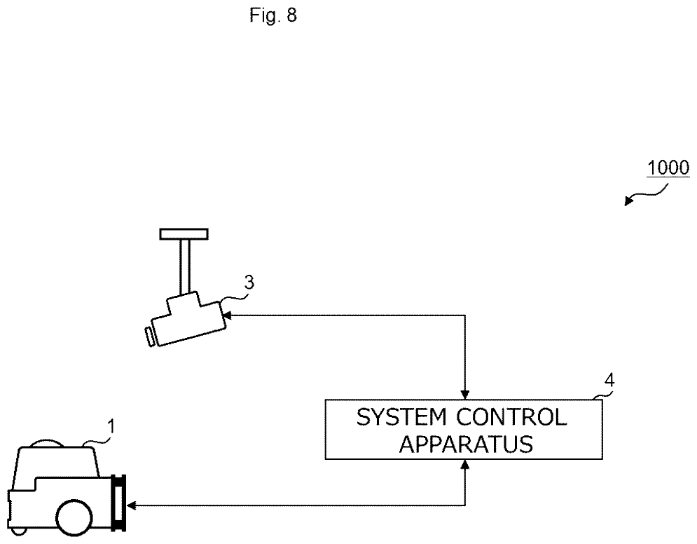

Next, with reference to FIG. 8 to FIG. 12, an operation mode of the transport system 1000 according to the first example embodiment of the present invention will be described. FIG. 8 is a block diagram illustrating an example of an operation mode of the transport system 1000. As illustrated in FIG. 8, the transport system 1000 includes at least one transport robot 1, the sensor 3 that transmits the movement region information related to the movement region of the transport robot 1, and the system control apparatus 4. Note that the transport system 1000 of the present example embodiment is an example of the movement control system.

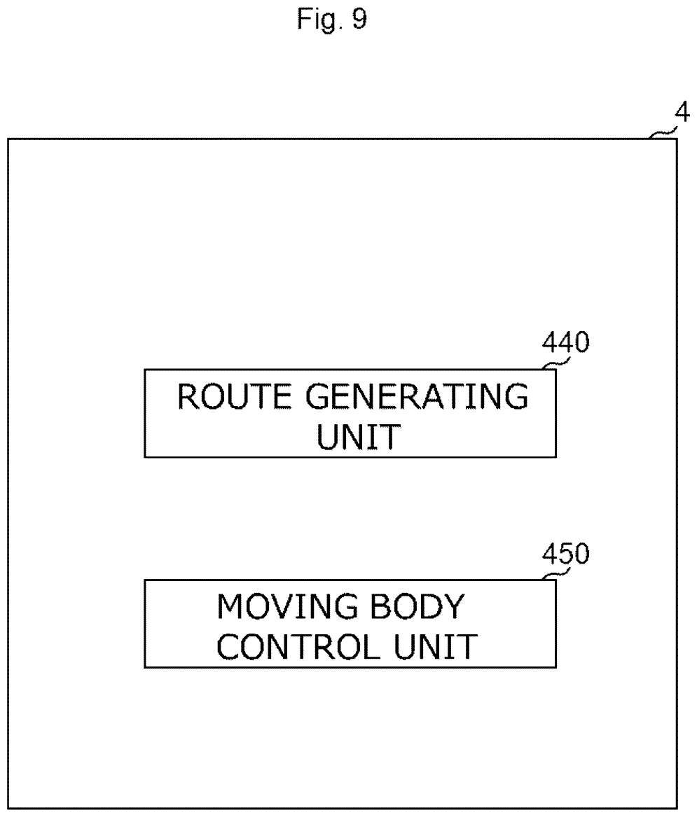

FIG. 9 is a functional block diagram illustrating an example of a schematic configuration of the system control apparatus 4 according to the first example embodiment. As illustrated in FIG. 9, the system control apparatus 4 includes a route generating unit 440 that generates a route of the transport robot 1 based on the movement region information received via the network, and a moving body control unit 450 that controls movement of the transport robot 1 based on the route.

The route generating unit 440 generates a route on which the transport robot 1 moves within a movement region AR1. For example, the route for allowing movement of the transport robot 1 in the movement region AR1 (see FIG. 10) of the transport robot 1 is generated using a route generation algorithm such as A*, a rapidly exploring random tree (RRT), and dynamic window approach (DWA).

The moving body control unit 450 generates control information for causing the transport robot 1 to move on the route, based on information related to the route generated by the route generating unit 440. The control information generated by the moving body control unit 450 is transmitted to the transport robot 1.

<2.5. Flow of Processing in Transport System>

FIG. 10 is a sequence diagram illustrating a flow of controlling movement of the transport robot 1 in the movement control system 1000. First, in Step S51, the sensor 3 transmits the movement region information related to the movement region AR1 of the transport robot 1 to the route generating unit 440. In Step S52, the route generating unit 440 specifies a first region 7A representing a position at which an object exists in the movement region AR1.

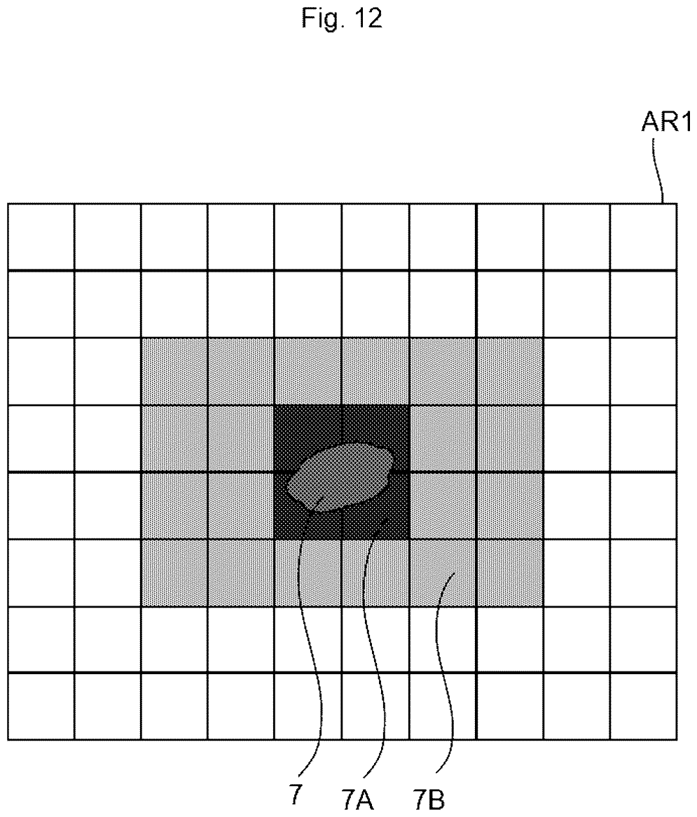

FIG. 12 is an explanatory diagram of a first region 7A and a second region 7B determined based on the position of the obstruction 7. In FIG. 12, the obstruction 7 is illustrated as an example of the object existing in the movement region AR1 of the transport robot 1. The obstruction 7 corresponds to, for example, a rack, a wall, another transport object, an item placed in the movement region AR1, a transport robot other than the transport robot 1, a workbench (table), a working machine, an item or the like dropped by a transport robot other than the transport robot 1 or a person (also including a person such as an operator), or an object existing in the movement region AR1. FIG. 12 illustrates an example in which the whole movement region AR1 is divided with a grid, and a grid in which the obstruction 7 exists is indicated with a dense dotted pattern as the first region 7A. Note that the first region 7A may have a shape of the obstruction 7 itself existing in the movement region AR1, for example, other than the rectangular shape as illustrated in FIG. 12.

Subsequently, in Step S53, the route generating unit 440 specifies the second region 7B. Specifically, in the movement region AR1, the route generating unit 440 specifies the first region 7A and surrounding grids at the first region 7A as the second region 7B. For example, the route generating unit 440 specifies, out of the movement region AR1, a region obtained by extending the first region 7A by a predetermined margin, a region obtained by adding up the first region 7A and a region to which n (n is a natural number) grids are added around the first region 7A, or a region obtained by extending the size of the obstruction 7 predetermined x times (x>1), as the second region. In other words, the second region 7B corresponds to a region including the first region 7A and a surrounding region at the first region 7A.

Note that the route generating unit 440 need not perform the extension in one direction. For example, the route generating unit 440 may specify the second region 7B by extending the first region 7A along a direction in which a path in a factory extends. In this manner, the extended region may be magnified at different rates depending on directions. For example, an extension rate of the second region 7B with respect to the first region 7A applied in a direction in parallel to the direction in which the path extends in the movement region AR1 and an extension rate of the second region 7B with respect to the first region 7A applied in a direction perpendicular thereto may be different rates.

Subsequently, in Step S54, the route generating unit 440 generates a route of the transport robot 1. For example, when the position of the obstruction 7 in the movement region AR1 is indicated with the movement region AR1 being divided with a grid, the route generating unit 440 may generate, as the route, a line connecting the grids as targets in movement of the transport robot 1. The route generating unit 440 may connect positions as targets in movement of the transport robot 1, and thereby generate, as the route, a route point group on which the transport robot 1 moves. The route point group corresponds to a set of points indicating the route on which the transport robot 1 travels. When the movement region AR1 is divided with a grid, the route point group may be a set of grids. A route point refers to a point in the route point group, which indicates the route. In this case, when an object such as the obstruction 7 exists in the movement region AR1, as the route of the transport robot 1, the route generating unit 440 generates an avoidance route for avoiding the second region 7B specified in Step S53.

Subsequently, in Step S55, the route generating unit 440 transmits route information related to the route generated in Step S54 to the moving body control unit 450. For example, when a line connecting the grids as targets in movement of the transport robot 1 is generated as the route, the route information corresponds to information indicating the grids as targets in movement of the transport robot 1. For example, when the positions as targets in movement of the transport robot 1 are connected and the route point group on which the transport robot 1 moves is thereby generated as the route, the route information corresponds to information indicating the grids including points as targets in movement of the transport robot 1, in other words, the grids in which the route points exist. When an object such as the obstruction 7 exists in the movement region AR1, the route information transmitted to the moving body control unit 450 includes information related to the avoidance route for avoiding the second region 7B.

When the moving body control unit 450 receives the route information, in Step S56, the moving body control unit 450 controls the transport robot 1 so that the transport robot 1 moves on the route.

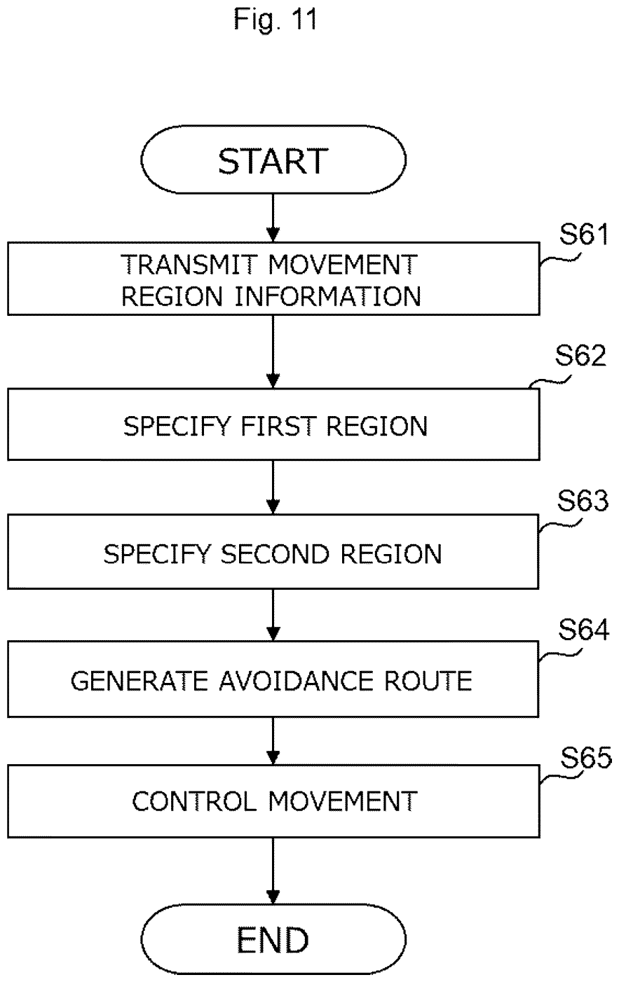

FIG. 11 is a flowchart illustrating a flow of controlling movement of the transport robot 1 in a movement control method according to the first example embodiment. The movement control method illustrated in the flowchart of FIG. 11 can be executed mainly by the transport system 1000. First, in Step S61, the movement region information related to the movement region AR1 of the transport robot 1 is transmitted. Subsequently, in Step S62, the first region 7A representing the position in which the object exists in the movement region AR1 is specified. Subsequently, in Step S63, the second region 7B including the first region 7A and a surrounding region at the first region 7A is specified.

Subsequently, in Step S64, the route of the transport robot 1 is generated. In this case, as the route of the transport robot 1, the avoidance route for avoiding the second region 7B specified in Step S63 is generated. Subsequently, in Step S65, the transport robot 1 is controlled so that the transport robot 1 moves on the avoidance route generated in Step S64.

As described above, in the first example embodiment of the present invention, the avoidance route on which the obstruction 7 existing in the movement region AR1 can be avoided is generated, when the route on which the transport robot 1 moves is generated in the movement region AR1 of the transport robot 1. With this configuration, the transport robot 1 can be prevented from coming too close to the obstruction 7, and therefore safety and efficiency in transport operation can be enhanced.

### 3. SECOND EXAMPLE EMBODIMENT

<3.1. Operation Mode of Transport System>

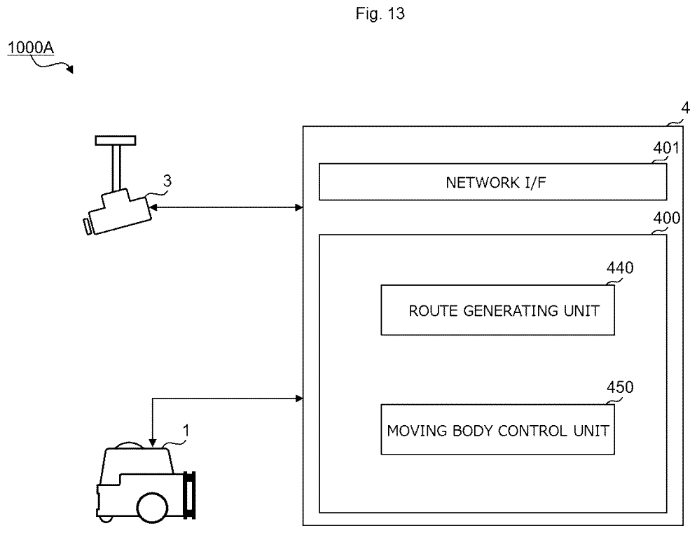

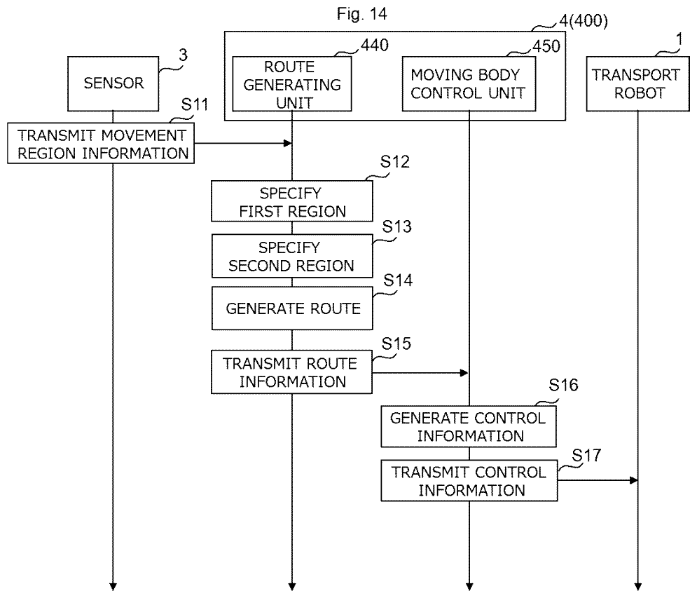

Next, with reference to FIG. 13 and FIG. 14, an overview of processing of generating a route on which the transport robot 1 moves according to a second example embodiment will be described. FIG. 13 is a diagram illustrating an operation mode of a transport system 1000A according to the first example embodiment. FIG. 14 is a sequence diagram illustrating a flow of controlling movement of the transport robot 1 in the transport system 1000A according to the first example embodiment.

First, an operation mode of the transport system 1000A according to the second example embodiment will be described. The first example embodiment will describe an operation mode of the transport system 1000A in so-called independent transport, in which the transport robot 1 independently transports the transport object 2. As illustrated in FIG. 13, in the transport system 1000A according to the second example embodiment, the sensor 3 and the system control apparatus 4 are connected via the network 6, and the system control apparatus 4 communicates with the transport robot 1. The system control apparatus 4 includes a network I/F 401 and a controller 400. Note that the transport system 1000A of the present example embodiment is an example of the movement control system.

The controller 400 executes generation of the route on which the transport robot 1 moves, movement control of the transport robot 1, and the like. The controller 400 is configured by dedicated software and programs being installed in the system control apparatus 4. The controller 400 includes the route generating unit 440 and the moving body control unit 450.

The route generating unit 440 generates a route on which the transport robot 1 moves within a movement region AR1. For example, the route for allowing movement of the transport robot 1 in the movement region AR1 (see FIG. 10) of the transport robot 1 is generated using a route generation algorithm such as A*, a rapidly exploring random tree (RRT), and dynamic window approach (DWA).

The moving body control unit 450 generates control information for causing the transport robot 1 to move on the route, based on information related to the route generated by the route generating unit 440. The control information generated by the moving body control unit 450 is transmitted to the transport robot 1.

Note that route information related to the route of the transport robot 1 may be transmitted from the system control apparatus 4 to the transport robot 1, such that movement of the transport robot 1 is controlled in the control unit 16 of the transport robot 1. The moving body control unit 450 may transmit the control information to the transport robot 1, and the control unit 16 of the transport robot 1 may control the transport robot 1 so that the transport robot 1 moves along the route.

<3.2. Flow of Processing in Transport System>

Next, with reference to FIG. 14, a flow of controlling movement of the transport robot 1 in the transport system 1000A will be described. In Step S11, the sensor 3 acquires information related to the movement region AR1 of the transport robot 1, and transmits the acquired information related to the movement region AR1 of the transport robot 1 to the system control apparatus 4 as the movement region information.

In Step S12, the route generating unit 440 specifies the first region 7A representing the position at which the object exists in the movement region AR1, based on the movement region information (see FIG. 12).

In Step S13, the route generating unit 440 specifies the second region 7B in the movement region AR1 (see FIG. 12).

Subsequently, in Step S14, the route generating unit 440 generates a route of the transport robot 1.

Subsequently, in Step S15, the route generating unit 440 transmits route information related to the route generated in Step S14 to the moving body control unit 450.

When the moving body control unit 450 receives the route information, the moving body control unit 450 generates control information for controlling the transport robot 1 in Step S16. Subsequently, in Step S17, the moving body control unit 450 transmits the control information generated in Step S16 to the transport robot 1. The transport robot 1 moves through the movement region AR1, based on the control information received from the system control apparatus 4.

In control processing of the transport robot 1 in the sequence diagram illustrated in FIG. 14, every time it is determined that the transport robot 1 has passed the predicted point of passage illustrated in FIG. 6, control information for the next predicted point of passage may be transmitted from the system control apparatus 4. In other words, in the system control apparatus 4, every time it is determined that the transport robot 1 has passed the predicted point of passage illustrated in FIG. 6, the control processing of the transport robot 1 illustrated in FIG. 14 may be executed. When an object enters a predicted point of passage that the transport robot 1 has not passed out of the predicted points of passage illustrated in FIG. 6, the system control apparatus 4 may transmit control information for stopping movement of the transport robot 1 to the transport robot 1.

As described above, in the second example embodiment of the present invention, the avoidance route on which the obstruction 7 existing in the movement region AR1 can be avoided is generated, when the route on which the transport robot 1 moves is generated in the movement region AR1 of the transport robot 1. With this configuration, the transport robot 1 can be prevented from coming too close to the obstruction 7, and therefore safety and efficiency in transport operation can be enhanced.

### 4. THIRD EXAMPLE EMBODIMENT

In the first and second example embodiments, the avoidance route for avoiding the obstruction 7 is generated as the route of the transport robot 1, based on the information related to the movement region of the transport robot 1. A third example embodiment is different from the first and second example embodiments in that the avoidance route for avoiding the obstruction 7 is generated based on the information related to the movement region, with information related to the transport object 2 being reflected, and movement of the transport robot 1 is thereby controlled. Note that, in description of the third example embodiment, elements the same as those in the first and second example embodiments may be denoted with the same reference signs in the drawings, and description thereof may be omitted.

<4.1. Operation Mode of Transport System>

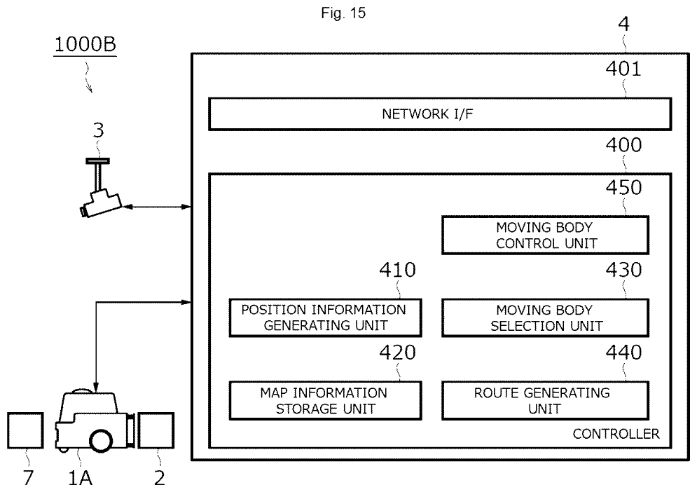

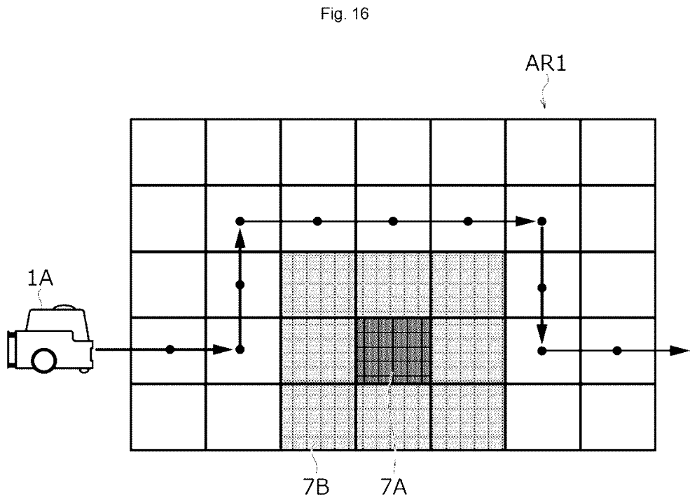

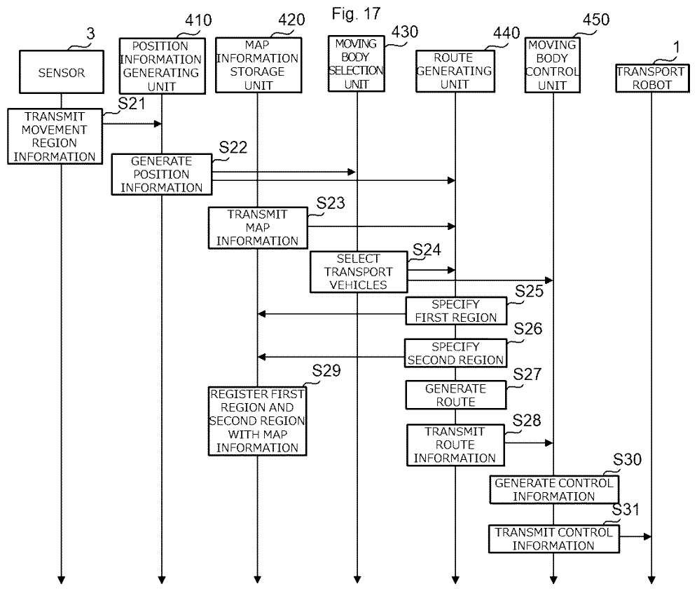

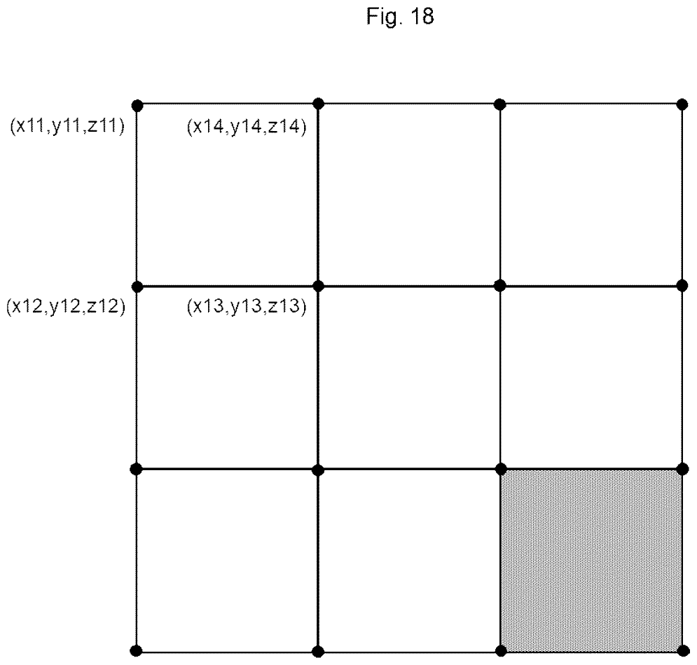

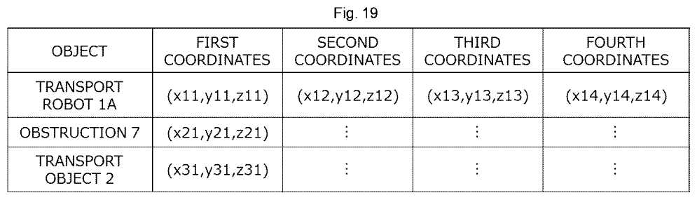

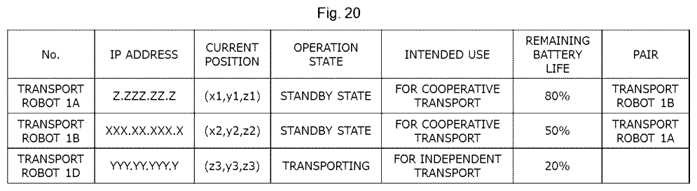

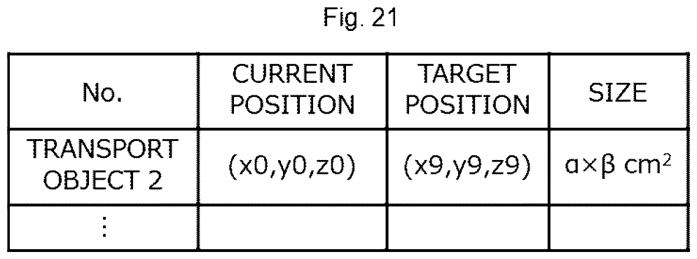

With reference to FIG. 15 to FIG. 21, the third example embodiment of the present invention will be described. The third example embodiment will describe an operation mode of a transport system 1000B in so-called independent transport, in which the transport robot 1 independently transports the transport object 2. FIG. 15 is a diagram illustrating an operation mode of the transport system 1000B according to the third example embodiment. FIG. 16 is an explanatory diagram of the avoidance route according to the third example embodiment. FIG. 17 is a sequence diagram illustrating a flow of controlling movement of the transport robot 1 in the transport system 1000B according to the third example embodiment. FIG. 18 is an explanatory diagram of position information according to the third example embodiment. FIG. 19 is a diagram illustrating an example of an information configuration of the position information. FIG. 20 is a diagram illustrating an example of an information configuration of moving body information related to moving bodies such as transport robots 1. FIG. 21 is a diagram illustrating an example of an information configuration of transport object information related to the transport object 2 transported by the moving body such as the transport robot 1.

As illustrated in FIG. 15, in the transport system 1000B according to the third example embodiment, the sensor 3 and the system control apparatus 4 are connected via the network 6, and the transport robot 1 that transports the transport object 2 communicates with the system control apparatus 4 via the AP 5. The system control apparatus 4 includes the network I/F 401 and the controller 400. Note that the transport system 1000B of the present example embodiment is an example of the movement control system.

The controller 400 executes generation of the position information of the object existing in the movement region AR1 of the transport robot 1, generation of the route of the transport robot 1, movement control of the transport robot 1, and the like. The controller 400 is configured by dedicated software and programs being installed in the system control apparatus 4. The controller 400 includes a position information generating unit 410, a map information storage unit 420, a moving body selection unit 430, a route generating unit 440, and a moving body control unit 450. The route generating unit 440 and the moving body control unit 450 are similar to those of the first and second example embodiments, and thus description thereof will be omitted.

The position information generating unit 410 generates the position information of an object such as the obstruction 7 existing in the movement region AR1 of the transport robot 1, based on the movement region information received from the sensor 3. The position information of the object in the present example embodiment corresponds to, for example, absolute coordinates and relative coordinates of the position of the object, the position at which the object exists in the movement region AR1 of the transport robot 1 (for example, an identification number of a grid when the movement region AR1 is divided with a grid), and the like. The position information generating unit 410 generates the transport object information related to the transport object 2 transported by the transport robot 1, based on the movement region information received from the sensor 3. Note that, when a sensor unit including an element corresponding to the position information generating unit 410 and the sensor 3 is included in the transport system 1000B, the position information of the object existing in the movement region AR1 of the transport robot 1 and the transport object information may be generated in the sensor unit.

The map information storage unit 420 stores information indicating the factory, the warehouse, or the like in which the transport robot 1 is installed and a wall, a traveling path, or the like in the movement region AR1, for example, as map information related to the movement region AR1 of the transport robot 1. The map information corresponds to, for example, information in which the wall, the traveling path, or the like in the movement region AR1 is associated with an identification number of a grid when the movement region AR1 is divided with a grid, or the like. The map information storage unit 420 stores region information related to the first region 7A and the second region 7B determined by the route generating unit 440, together with the map information.

The moving body selection unit 430 includes the moving body information related to moving bodies such as the transport robots 1 included in the transport system 1000B, and selects a moving body (for example, the transport robot 1) that transports the transport object 2, based on the moving body information and the transport object information.

Note that route information related to the route of the transport robot 1 may be transmitted from the system control apparatus 4 to the transport robot 1, such that movement of the transport robot 1 is controlled based on the route information received by the control unit 16 of the transport robot 1. With the moving body control unit 450 having transmitted the control information to the transport robot 1, movement of the transport robot 1 may be controlled such that the transport robot 1 moves on the route, based on the control information received by the control unit 16 of the transport robot 1.

<4.2. Method of Generating Avoidance Route>

In the present example embodiment, the route generating unit 440 acquires the position information of the obstruction 7, the transport object information, and the moving body information, and determines the first region 7A and the second region 7B in the movement region AR1 of the transport robot 1. Then, the route generating unit 440 generates the route point group so that the second region 7B is avoided, and thereby generates the route of the transport robot 1. FIG. 16 illustrates the route point group generated by the route generating unit 440 with black circles in the movement region AR1 of the transport robot 1. As illustrated in FIG. 16, the route generating unit 440 further selects a plurality of route points out of the route point group generated in the movement region AR1 of the transport robot 1, and thereby generates the route of the transport robot 1.

<4.3. Flow of Processing in Transport System>

Next, with reference to FIG. 17, a flow of processing of controlling movement of the transport robot 1 in the transport system 1000B will be described. In Step S21, the sensor 3 acquires information related to the movement region AR1 of the transport robot 1, and transmits the acquired information related to the movement region AR1 of the transport robot 1 to the system control apparatus 4 as the movement region information.

In Step S22, the position information generating unit 410 generates the position information related to the position of the obstruction 7 or the like existing in the movement region AR1 and the transport object information related to the transport object 2, based on the movement region information received from the sensor 3.

Here, with reference to FIG. 18, FIG. 19, and FIG. 20, the position information and the transport object information generated by the position information generating unit 410 will be described. In the present example embodiment, as illustrated in FIG. 18, the whole movement region AR1 is divided with a grid, and coordinates are given to each of vertices being intersections of grid lines. As illustrated in FIG. 19, as the position information indicating the grid in which the transport robot 1, the obstruction 7, or the transport object 2 exists, information including coordinates of four or more vertices is generated by the position information generating unit 410. The position information indicates that an object such as the transport robot 1, the obstruction 7, or the transport object 2 exists in a region in the movement region AR1 defined by grid lines specified with the coordinates of four or more vertices.

The position information of FIG. 19 indicates that a transport robot 1A exists in a region in the movement region AR1 defined by grid lines specified with first coordinates “x11, y11, z11”, second coordinates “x12, y12, z12”, third coordinates “x13, y13, z13”, and fourth coordinates “x14, y14, z14”. The position information generating unit 410 specifies the position of the object existing in the movement region AR1, based on the movement region information received from the sensor 3, and generates information indicating the position of the region in the movement region AR1 occupied by the object as the position information. The position information generating unit 410 transmits the position information to the moving body selection unit 430 and the route generating unit 440.

The position information generating unit 410 generates the transport object information related to the transport object 2 existing in the movement region AR1, based on the movement region information received from the sensor 3. Regarding the position of the region in the movement region AR1 in which the transport object 2 exists, the transport object information of FIG. 20 includes information of the current position indicating coordinates of a top left vertex and information of the size indicating the size of the transport object 2. Note that, when information indicating a transport target position of the transport object 2 is transmitted from an external input apparatus, such as a tablet terminal and a portable communication terminal operated by an operator of the transport system 1000B, to the system control apparatus 4, information of a target position indicating coordinates of the transport target position of the transport object 2 may be included in the transport object information. As the transport object information, information related to height of the transport object 2 and information related to weight of the transport object 2 may be included. The position information generating unit 410 transmits the transport object information to the moving body selection unit 430.

Subsequently, in Step S23, the map information storage unit 420 transmits information indicating a wall, a traveling path, or the like in the factory, the warehouse, or the like in which the moving body such as the transport robot 1 is installed to the route generating unit 440 as the map information related to the movement region AR1.

Subsequently, in Step S24, the moving body selection unit 430 selects a moving body that transports the transport object 2 out of the moving bodies included in the transport system 1000B, based on the transport object information. The following description is herein given based on an assumption that the transport robot 1A is selected as the moving body that transports the transport object 2.

The moving body selection unit 430 stores the moving body information related to the moving bodies included in the transport system 1000B. The moving body information illustrated in FIG. 20 includes, for example, information of an IP address of each moving body, information of the current position of each moving body in the movement region AR1, information of an operation state of each moving body, information of intended use of each moving body, information of a remaining battery power of each moving body, and information related to another moving body with which cooperative transport can be performed.

Regarding the transport robot 1A, the moving body information illustrated in FIG. 20 includes information indicating that the IP address is “Z.ZZZ.ZZ.Z”, the coordinates of the top left vertex indicating the current position are “x11, y11, z11”, the operation state is a “standby state”, the intended use is “capable of cooperative transport”, and the remaining battery power is “80%”. Regarding a transport robot 1B, the moving body information includes information indicating that the IP address is “XXX.XX.XXX.X”, the coordinates of the top left vertex indicating the current position are “x2, y2, z2”, the operation state is a “standby state”, the intended use is “capable of cooperative transport”, and the remaining battery power is “50%”. Regarding a transport robot 1D, the moving body information includes information indicating that the IP address is “YYY.YY.YYY.Y”, the coordinates of the top left vertex indicating the current position are “x3, y3, z3”, the operation state is “independently transporting”, the intended use is “for independent transport”, and the remaining battery power is “20%”. Note that the coordinates indicating the current position of the transport robot 1 included in the moving body information are not limited to top left coordinates. For example, instead of the top left coordinates, top right, bottom left, bottom right, and center coordinates may be used, for example.

In Step S24, the moving body selection unit 430 selects a moving body having the most remaining battery power, out of the moving bodies in the standby state, as the moving body that transports the transport object 2, based on the moving body information. Accordingly, as described above, in Step S24, the moving body selection unit 430 selects the transport robot 1A as the moving body that transports the transport object 2. Note that, other than the above configuration, for example, the moving body selection unit 430 may select a moving body located at a position closest to the transport object 2, out of the moving bodies in the standby state, as the moving body that transports the transport object 2, based on the moving body information. The moving body information of the moving body selected by the moving body selection unit 430 as the moving body that transports the transport object 2 is transmitted to the route generating unit 440 and the moving body control unit 450.

In Step S25, the route generating unit 440 specifies the first region 7A (see FIG. 16), based on the map information related to the movement region AR1 and the position information related to the position of the obstruction 7 or the like existing in the movement region AR1.

Subsequently, in Step S26, the route generating unit 440 specifies the first region 7A and a surrounding region at the first region 7A as the second region 7B. Specifically, the route generating unit 440 specifies the first region 7A specified in Step S25 and a surrounding region at the first region 7A as the second region 7B. The route generating unit 440 specifies a range to set as the second region 7B, based on a minimum curve radius or the like when the transport object 2 is transported by the transport robot 1, for example. With this configuration, the second region 7B can be specified depending on the size of the transport object 2. For example, when a long transport object 2 is transported, a larger second region 7B can be specified. Therefore, in the present example embodiment, the obstruction 7 or the like existing in the movement region AR1 can be more appropriately avoided, depending on the size of the transport object 2 transported by the transport robot 1. Note that the route generating unit 440 transmits the region information related to the specified first region 7A and second region 7B to the map information storage unit 420.

Subsequently, in Step S27, the route generating unit 440 generates the route of the transport robot 1 as described with reference to FIG. 16. When an object such as the obstruction 7 exists in the movement region AR1, as the route of the transport robot 1, the route generating unit 440 generates the route point group for avoiding the second region 7B specified in Step S26, selects a plurality of route points out of the route point group, and thereby generates the avoidance route.

Note that, as the route of the transport robot 1, the route generating unit 440 generates the avoidance route so as to prohibit entry of the second region 7B transported by the transport robot 1 into the transport object 2. This can enhance safety of transport operation in the transport robot 1.

Subsequently, in Step S28, the route generating unit 440 transmits the route information related to the route generated in Step S27 to the map information storage unit 420 and the moving body control unit 450. When an object such as the obstruction 7 exists in the movement region AR1, the route information transmitted to the moving body control unit 450 includes information related to the avoidance route for avoiding the first region 7A and the second region 7B.

In Step S29, the map information storage unit 420 stores the region information indicating the first region and the second region received from the route generating unit 440, together with the map information. Note that the map information storage unit 420 may update the region information stored together with the map information, when the position of the obstruction 7 existing in the movement region AR1 changes. With this configuration, when the position of the obstruction 7 remains unchanged, the route can be generated based on the information stored in the map information storage unit 420.

When the moving body control unit 450 receives the route information, the moving body control unit 450 generates control information for controlling the transport robot 1 in Step S30. In this case, the moving body control unit 450 transmits control information for controlling the transport robot 1 so as to move along the route, based on the route information.

Subsequently, in Step S31, the moving body control unit 450 transmits the control information generated in Step S30 to the transport robot 1. The transport robot 1 moves through the movement region AR1, based on the control information received from the system control apparatus 4.

Note that, after the route is generated by the route generating unit 440, a moving body (for example, the transport robot 1) that can move along the route generated by the route generating unit 440 may be selected, and the moving body may be caused to transport the transport object 2.

As described above, in the third example embodiment of the present invention, the avoidance route on which the obstruction 7 existing in the movement region AR1 can be avoided is generated, when the route on which the transport robot 1 moves is generated in the movement region AR1 of the transport robot 1. With this configuration, the transport robot 1 can be prevented from coming too close to the obstruction 7, and therefore safety and efficiency in transport operation can be enhanced.

In the third example embodiment, the second region 7B is specified based on the transport object information related to the transport object 2 transported by the transport robot 1. Therefore, even when a turning radius difference is generated between a movement locus of the transport robot 1 and a movement locus of the transport object 2 in transport of the transport object 2, collision between the obstruction 7 and the transport object 2 can be reduced.

### 5. FOURTH EXAMPLE EMBODIMENT

In the first to third example embodiments, a configuration of controlling movement of the transport robot 1 that independently transports the transport object 2 has been described. In a fourth example embodiment, a transport system 1000C in which the transport object 2 can be cooperatively transported by the transport robot 1A and the transport robot 1B will be described. The fourth example embodiment is different from the first to third example embodiments in that the transport object 2 is cooperatively transported by a plurality of transport robots 1 (for example, the transport robots 1A and 1B) and that an element that predicts movement results when the transport robots 1A and 1B move on a route is included. Note that, in description of the fourth example embodiment, elements the same as those in the first to third example embodiments may be denoted with the same reference signs in the drawings, and description thereof may be omitted.

<5.1. Operation Mode of Transport System>

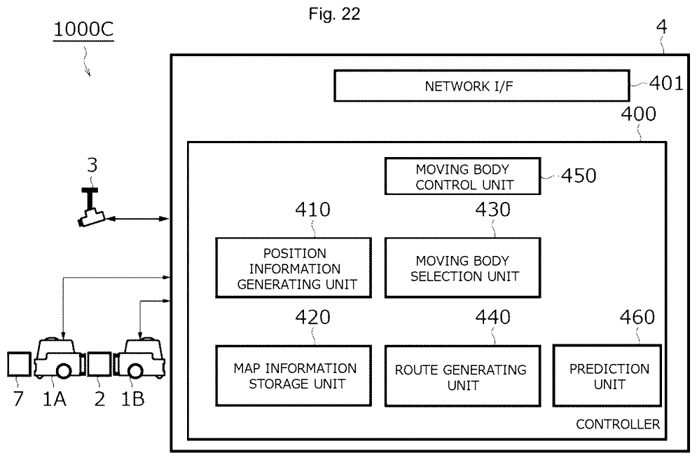

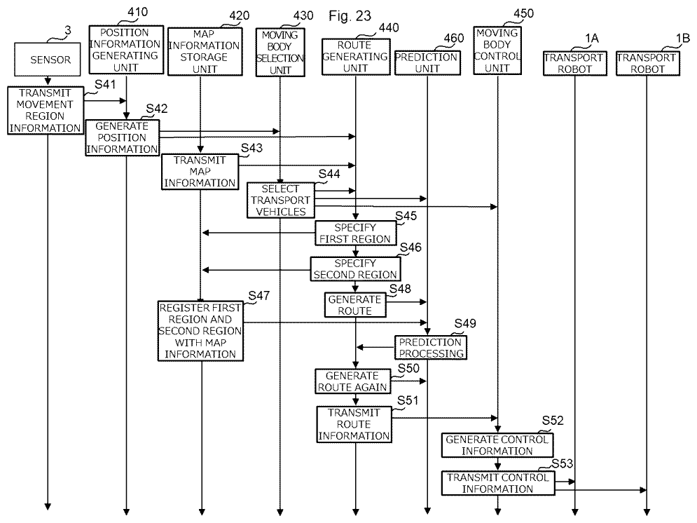

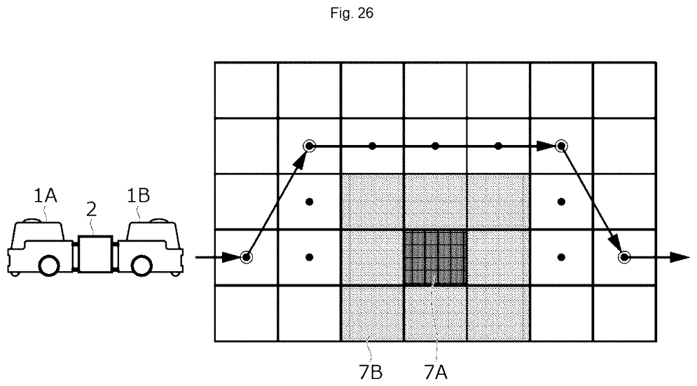

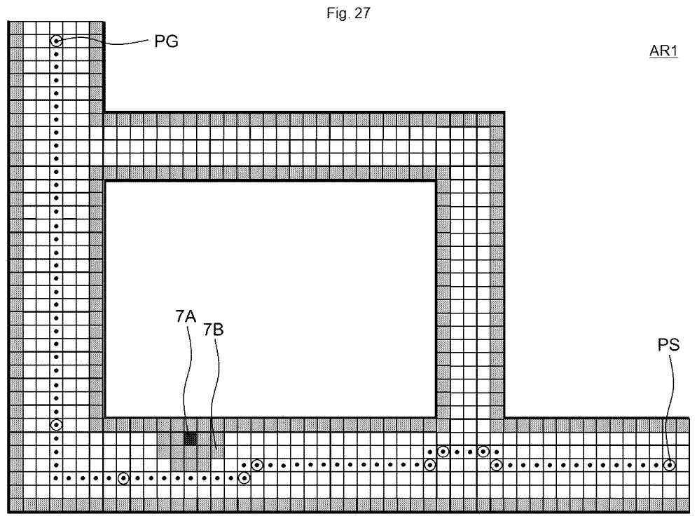

With reference to FIG. 22 to FIG. 27, the third example embodiment of the present invention will be described. FIG. 22 is a diagram illustrating an operation mode of the transport system 1000C according to the fourth example embodiment. FIG. 23 is a sequence diagram illustrating a flow of controlling movement of the transport robots 1A and 1B in the transport system 1000C according to the fourth example embodiment. FIG. 24 is a plan view schematically illustrating an example of cooperative transport. FIG. 25 is a side view schematically illustrating an example of cooperative transport. FIG. 26 is an explanatory diagram of the avoidance route according to the fourth example embodiment. FIG. 27 is a general view of the movement region AR1 according to the fourth example embodiment.

First, with reference to FIG. 22, FIG. 24, and FIG. 25, cooperative transport according to the present example embodiment will be described. As illustrated in FIG. 22, the transport system 1000C of the fourth example embodiment is capable of executing so-called cooperative transport, in which the transport object 2 is transported by the transport robot 1A and the transport robot 1B in cooperation with each other. In the transport system 1000C according to the fourth example embodiment, the sensor 3 and the system control apparatus 4 are connected via the network 6, and the transport robots 1A and 1B that transport the transport object 2 communicate with the system control apparatus 4 via the AP 5. The system control apparatus 4 includes the network I/F 401 and the controller 400. Note that the transport system 1000C of the present example embodiment is an example of the movement control system.

The “cooperative transport” according to the present example embodiment corresponds to an operation of transporting the transport object 2 through cooperative operations of a plurality of transport robots 1. As an example of executing the cooperative transport by the transport robots 1A and 1B, FIG. 22 illustrates the transport system 1000C when the cooperative transport is executed with the transport object 2 being interposed between the transport robots 1A and 1B. In the present example embodiment, as illustrated in FIG. 24 and FIG. 25, the cooperative transport can be performed, with the transport object 2 being a cart, a dolly, or the like including a plurality of freely turnable casters 71, 72, 73, and 74 on a base 70 to be loaded with a burden 2A. Note that the transport object 2 may be an object (for example, a cardboard box or the like) not including wheels such as casters. Each of the transport robots 1A and 1B can also independently transport the transport object 2. In addition, the transport robots 1A and 1B can also move without transporting the transport object 2. In the following description, when the transport robots 1A and 1B need not be distinguished from each other, the transport robots 1A and 1B may be referred to as the “transport robots 1”.

As illustrated in FIG. 24 and FIG. 25, when the cooperative transport is performed in such a manner that the transport robot 1B moves after the transport robot 1A, the transport robots 1A and 1B transport the transport object 2 with the transport object 2 being interposed between the contact part 30 of the transport robot 1A and the contact part 30 (see FIG. 3 and FIG. 4) of the transport robot 1B. In this case, the contact part 30 of each of the transport robots 1A and 1B receives a contact load from the transport object 2. The contact part 30 includes the plate members 31 and 32, the friction part 33, and the elastic members 34, 35, 36, and 37 (see FIG. 3 and FIG. 4), and by detecting a distance between the plate members 31 and 32, a contact load when the contact part 30 and the transport object 2 come in contact with each other can be detected. Note that the contact load when the contact part 30 and the transport object 2 come in contact with each other is detected by the load sensor 23 (see FIG. 5). One of the contact part 30 of the transport robot 1A and the contact part 30 of the transport robot 1B corresponds to a first pressurizing unit of the present example embodiment, and the other corresponds to a second pressurizing unit of the present example embodiment.

Next, control information transmitted to the control unit 16 of the transport robot 1A and the control unit 16 (see FIG. 5) of the transport robot 1B from the system control apparatus 4 when the transport robot 1A and the transport robot 1B cooperatively transport the transport object 2 will be described. Here, it is assumed that the transport robot 1A is a leading moving body that moves foremost, and the transport robot 1B is a succeeding moving body that moves afterwards. The communication unit 17 of the transport robot 1A corresponds to a leading moving body communication unit. The drive units 12 and 13 of the transport robot 1A each correspond to a leading moving body drive unit. The control unit 16 of the transport robot 1A corresponds to a leading moving body drive control unit. Moreover, the communication unit 17 of the transport robot 1B corresponds to a succeeding moving body communication unit. The drive units 12 and 13 of the transport robot 1B each correspond to a succeeding moving body drive unit. The control unit 16 of the transport robot 1B corresponds to a succeeding moving body drive control unit. The load sensor 23 of the transport robot 1B corresponds to a state detection unit.

On an assumption that the transport robot 1A moves by the distance d within the period of time Δt (see FIG. 7), a velocity vLr of the wheel 20 and a velocity vLl of the wheel 21 of the transport robot 1A can be calculated based on Expression (2-1).

$$\begin{matrix}[ Math . 2 ] & \\ {v}_{r , l}^{L} = \frac{Φ}{Δ t} ( \frac{d}{sin Φ} \pm l ) & Expression ( 2 - 1 )\end{matrix}$$

In Expression (2-1), “Φ” corresponds to an angle between a line connecting a point away from the transport robot 1A by the distance d and the transport robot 1A and an imaginary line indicating a moving direction of the transport robot 1A.

When the transport robot 1A transports the transport object 2 by means of cooperative transport with the transport robot 1B, the system control apparatus 4 transmits the velocity vLr of the drive unit 12 and the velocity vLl of the drive unit 13 of the transport robot 1A, which can be calculated based on Expression (2-1), to the transport robots 1A and 1B as control information. In other words, the system control apparatus 4 transmits the control information to the transport robot 1B, which is the same control information as that for the transport robot 1A.

Next, control of the transport robot 1B after the transport robot 1B receives the control information will be described. The control unit 16 of the transport robot 1B executes velocity control of the transport robot 1B in a front-and-back direction and velocity control of the transport robot 1B in a right-and-left direction.

First, the velocity control of the transport robot 1B in the front-and-back direction will be described. The control unit 16 of the transport robot 1B controls the drive units 12 and 13 of the transport robot 1B so that the transport robot 1B follows the leading transport robot 1A, based on detection results of the load sensor 23 in the transport robot 1B.

First, the control unit 16 of the transport robot 1B calculates a difference Δd of a distance between the plate member 31 and the plate member 32 of the transport robot 1B, based on the detection results of the load sensor 23 (Expression (2-2)). In Expression (2-2), “dt” represents a target distance between the plate member 31 and the plate member 32, and “dp” represents an actual distance between the plate member 31 and the plate member 32 detected by the load sensor 23. Note that the target distance between the plate member 31 and the plate member 32 is set in advance so that the cooperative transport can be performed together with the transport robot 1A.

[Math. 3]

Δd=dt−dp Expression (2-2)

Next, the control unit 16 of the transport robot 1B corrects the difference Δd of the distance between the plate member 31 and the plate member 32 of the transport robot 1B, using νβ (Expression (2-3)). νβ is a value proportional to a deviation between the target distance dt between the plate member 31 and the plate member 32 and the actual distance dp between the plate member 31 and the plate member 32. Kd is a gain coefficient.

[Math. 4]

ν_{β}=K_{d}Δd Expression (2-3)

Next, the control unit 16 of the transport robot 1B determines a velocity of the transport robot 1B in the front-and-back direction, based on the control information received from the system control apparatus 4 and νβ calculated based on Expression (2-3) (Expression (2-4)).

$$\begin{matrix}[ Math . 5 ] & \\ {v}_{r , l}^{F} = \frac{{v}_{r}^{L} + {v}_{l}^{L}}{2} + {v}_{β} & Expression ( 2 - 4 )\end{matrix}$$

Specifically, when the distance dp between the plate member 31 and the plate member 32 becomes larger than the target distance dt, for example, the control unit 16 of the transport robot 1B controls the drive units 12 and 13 so that a velocity vF of the transport robot 1B is increased. In contrast, when the distance dp between the plate members 31 and 32 becomes smaller than the target distance dt, for example, the control unit 16 of the transport robot 1B controls the drive units 12 and 13 so that the velocity vF of the transport robot 1B is decreased.

When the distance dp between the plate member 31 and the plate member 32 becomes larger than the target distance dt, for example, the control unit 16 of the transport robot 1A controls the drive units 12 and 13 so that a velocity vL of the transport robot 1A is decreased. In contrast, when the distance dp between the plate members 31 and 32 becomes smaller than the target distance dt, for example, the control unit 16 of the transport robot 1A controls the drive units 12 and 13 so that the velocity vL of the transport robot 1B is increased. When the cooperative transport is performed, the state in which the transport object 2 is interposed by the transport robots 1A and 1B with a certain force is maintained as described above.

Next, the velocity control of the transport robot 1B in the right-and-left direction will be described. In the velocity control of the transport robot 1B in the right-and-left direction, the control unit 16 of the transport robot 1B controls the velocity of the transport robot 1B so that an angle of rotation of the contact part 30 is a target value θt. Here, the target value θt is an angle determined on an assumption that the transport robot 1B is located immediately behind the transport robot 1A.

First, the control unit 16 of the transport robot 1B determines the target value θt of the angle of rotation of the contact part 30 (Expression (2-5)).

$$\begin{matrix}[ Math . 6 ] & \\ {θ}_{t} = arctan ( \frac{2 L}{l} \frac{{v}_{r} - {v}_{l}}{{v}_{r} + {v}_{l}} ) & Expression ( 2 - 5 )\end{matrix}$$

In Expression (2-5), “L” corresponds to a distance between the transport robot 1A and the transport robot 1B, “r” corresponds to a curve radius of the transport robot 1A, and “1” corresponds to a distance between the wheels 20 and 21 of the transport robot 1B.

Subsequently, the control unit 16 of the transport robot 1B calculates a difference Δθ between an angle θ of the contact part 30 of the transport robot 1B detected by the angle sensor 24 and the target value θt of the angle of rotation of the contact part 30 (Expression (2-6)).

[Math. 7]

Δθ=θₜ−θ Expression (2-6)

Subsequently, the control unit 16 of the transport robot 1B corrects the difference Δθ between the angle θ of the contact part 30 of the transport robot 1B and the target value θt of the angle of rotation of the contact part 30, using νγ (Expression (2-7)). νγ is a value proportional to a deviation between the angle θ of the contact part 30 of the transport robot 1B and the target value θt of the angle of rotation of the contact part 30. Kγ is a gain coefficient.

[Math. 8]

ν_{γ}=K_{γ}Δθ Expression (2-7)

Subsequently, the control unit 16 of the transport robot 1B determines the velocity of the transport robot 1B in the right-and-left direction, based on the control information received from the system control apparatus 4, νβ calculated based on Expression (2-3), and νγ calculated based on Expression (2-7) (Expression (2-8)).

$$\begin{matrix}[ Math . 9 ] & \\ {v}_{r , l}^{F} = \frac{{v}_{r}^{L} + {v}_{l}^{L}}{2} + {v}_{β} \pm {v}_{γ} & Expression ( 2 - 8 )\end{matrix}$$

With this configuration, the control unit of the transport robot 1B controls the drive units 12 and 13 of the transport robot 1B so that the transport robot 1B moves in a manner of following the leading transport robot 1A in a moving direction of the leading transport robot 1A, based on the detection results of the angle sensor 24 in the transport robot 1B.

Note that feedback control based on the detection results of the load sensor 23 may be omitted in the transport robot 1A, and feedback control based on the detection results of the load sensor 23 and the angle sensor 24 may be performed only in the transport robot 1B. The feedback control may be, for example, proportional integral differential (PID) control, in which control of an input value is performed using three elements, namely a deviation between an output value and a target value in each of the load sensor 23 and the angle sensor 24, integral of the deviation, and differential of the deviation.

In addition to transmission of the same control information as the transport robot 1A from the system control apparatus 4 to the transport robot 1B, the transport robot 1B may move in a manner of following movement of the transport robot 1A as follows. For example, the control unit 16 of the transport robot 1A may generate and transmit control information of the transport robot 1B, based on the control information received from the system control apparatus 4. For example, the system control apparatus 4 may transmit the control information of the transport robot 1B to the transport robot 1B.

Next, with reference to FIG. 22, a functional configuration of the system control apparatus 4 according to the present example embodiment will be described. The controller 400 executes generation of the position information of the object existing in the movement region of the transport robots 1A and 1B, generation of the route of the transport robots 1A and 1B, prediction of movement of the transport robots 1A and 1B on the route, movement control of the transport robots 1A and 1B, and the like. The controller 400 is configured by dedicated software and programs being installed in the system control apparatus 4. The controller 400 includes a position information generating unit 410, a map information storage unit 420, a moving body selection unit 430, a route generating unit 440, a moving body control unit 450, and a prediction unit 460. The position information generating unit 410, the map information storage unit 420, the moving body selection unit 430, the route generating unit 440, and the moving body control unit 450 are similar to those of the first to third example embodiments, and thus description thereof will be omitted.

The prediction unit 460 predicts a movement locus when the transport robots 1A and 1B move on the route of the transport robots 1A and 1B generated by the route generating unit 440. Prediction results of the prediction unit 460 are transmitted to the route generating unit 440. The route generating unit 440 may generate a new route of the transport robots 1A and 1B, based on the prediction results by the prediction unit 460.

Specifically, the prediction unit 460 determines whether or not there is a possibility that the transport robots 1A and 1B and the transport object 2 collide with the obstruction 7 existing in the movement region AR1, based on the movement locus when the transport robots 1A and 1B are caused to move in arc motion along the route generated by the route generating unit 440, for example. The prediction unit 460 determines that there is a possibility that the transport robots 1A and 1B and the transport object 2 collide with the obstruction 7 existing in the movement region AR1 when the movement locus of the transport robots 1A and 1B and the movement locus of the transport object 2 enter the first region 7A in the movement region AR1, for example. Results of prediction processing by the prediction unit 460 are transmitted to the route generating unit 440.

Note that the prediction unit 460 may prohibit entry of the transport object 2 transported by the transport robots 1A and 1B into the first region 7A and permit entry thereof into the second region 7B in prediction when the transport robots 1A and 1B move on the route.

<5.2. Method of Generating Avoidance Route>

In the present example embodiment, the route generating unit 440 acquires the position information of the obstruction 7, the transport object information, and the moving body information, and determines the first region 7A and the second region 7B in the movement region of the transport robot 1. Then, the route generating unit 440 generates the route point group so that the first region 7A and the second region 7B are avoided, and thereby generates the route of the transport robots 1A and 1B. FIG. 26 illustrates the route point group generated by the route generating unit 440 with black circles in the movement region of the transport robots 1A and 1B. The route generating unit 440 further selects a plurality of route points out of the route point group generated in the movement region of the transport robots 1A and 1B, connects the plurality of route points, and thereby generates the route of the transport robots 1. An example of a cooperative transport route of the present example embodiment is the route on which the transport robots 1A and 1B cooperatively transport the transport object 2.

For example, the route generating unit 440 selects a plurality of route points out of the route point group and generates the route, and smoothes the generated route, based on a simplification algorithm such as the Ramer-Douglas-Peucker algorithm. FIG. 26 and FIG. 27 illustrate the route points included in the smoothed route with black circles surrounded by solid-line circles.

With this configuration, as illustrated in the general view of the movement region AR1 of FIG. 27, for example, using the Ramer-Douglas-Peucker algorithm, a line connecting the starting point PS and the end point PG is approximated with straight line(s) as the route of the transport robots 1A and 1B. In other words, in comparison to the route of the transport robot 1A generated in the third example embodiment, the route of the transport robots 1A and 1B generated in the present example embodiment has a smaller number of times the transport robot 1A changes the moving direction. Therefore, when the transport robots 1A and 1B move along the route, the number of times the transport robot 1A changes the moving direction can be reduced, and accordingly a load of control of the transport robot 1B can be reduced in the cooperative transport of the transport robots 1A and 1B.

<5.3. Flow of Processing in Transport System>

Next, with reference to FIG. 23, a flow of processing of controlling movement of the transport robots 1 in the transport system 1000C will be described. In Step S41, the sensor 3 acquires information related to the movement region AR1 of the transport robots 1, and transmits the acquired information related to the movement region AR1 of the transport robots 1 to the system control apparatus 4 as the movement region information.

In Step S42, the position information generating unit 410 generates the position information related to the position of the obstruction 7 or the like existing in the movement region AR1 and the transport object information related to the transport object 2, based on the movement region information received from the sensor 3. The position information generating unit 410 transmits the position information to the moving body selection unit 430 and the route generating unit 440, and transmits the transport object information to the moving body selection unit 430.

Subsequently, in Step S43, the map information storage unit 420 transmits information indicating a wall, a traveling path, or the like in the factory, the warehouse, or the like in which the moving bodies such as the transport robots 1 are installed to the route generating unit 440 as the map information related to the movement region AR1.

Subsequently, in Step S44, the moving body selection unit 430 selects moving bodes that transport the transport object 2 out of the moving bodies included in the transport system 1000C, based on the transport object information. The following description is herein given based on an assumption that the transport robot 1A and the transport robot 1B are selected as the moving bodies that transport the transport object 2.

The moving body selection unit 430 stores the moving body information related to the moving bodies included in the transport system 1000C (see FIG. 20). In Step S44, the moving body selection unit 430 selects two moving bodies capable of the cooperative transport, out of the moving bodies in the standby state, as the moving bodies that transport the transport object 2, based on the moving body information. In the moving body information illustrated in FIG. 20, for example, information indicating that the transport robot 1A and the transport robot 1B are moving bodies that are capable of the cooperative transport and are in the standby state is included.

Accordingly, as described above, in Step S44, the moving body selection unit 430 selects the transport robot 1A and the transport robot 1B as the moving bodies that transport the transport object 2. Note that, other than the above configuration, for example, the moving body selection unit 430 may select two moving bodies that are located at positions closest to the transport object 2 and are in the standby state, out of the moving bodies in the standby state, as the moving bodies that transport the transport object 2, based on the moving body information. The moving body information of the moving bodies selected by the moving body selection unit 430 as the moving bodies that transport the transport object 2 is transmitted to the route generating unit 440, the moving body control unit 450, and the prediction unit 460.

In Step S45, the route generating unit 440 specifies the first region 7A (see FIG. 26 and FIG. 27), based on the map information related to the movement region AR1 and the position information related to the position of the obstruction 7 or the like existing in the movement region AR1. The region information related to the first region 7A and the second region 7B specified by the route generating unit 440 is transmitted to the map information storage unit 420.

Subsequently, in Step S46, the route generating unit 440 specifies a region including the first region 7A and a surrounding region at the first region as the second region 7B (see FIG. 26 and FIG. 27). Specifically, the route generating unit 440 specifies a range to set as the second region 7B, based on the transport object information related to the transport object 2 and the moving body information related to the transport robots 1. The route generating unit 440 specifies the range to set as the second region 7B, based on a minimum curve radius or the like when the transport object 2 is cooperatively transported by the transport robots 1A and 1B, for example.

In Step S47, the map information storage unit 420 stores the region information indicating the first region and the second region received from the route generating unit 440, together with the map information. Note that the map information storage unit 420 may update the region information stored together with the map information, when the position of the obstruction 7 existing in the movement region AR1 changes. With this configuration, when the position of the obstruction 7 remains unchanged, the route can be generated based on the information stored in the map information storage unit 420. The map information stored in the map information storage unit 420 is transmitted to the prediction unit 460.

Subsequently, in Step S48, the route generating unit 440 generates the route of the transport robots 1A and 1B as described with reference to FIG. 26. When an object such as the obstruction 7 exists in the movement region AR1, as the route of the transport robots 1A and 1B, the route generating unit 440 generates the route point group for avoiding the first region 7A and the second region 7B specified in Step S45 and Step S46, selects a plurality of route points out of the route point group, and thereby generates the avoidance route. A line connecting the route points indicated with the black circles surrounded by solid-line circles in FIG. 27 corresponds to the avoidance route generated by the route generating unit 440. The route information related to the route generated by the route generating unit 440 is transmitted to the prediction unit 460.

Subsequently, in Step S49, the prediction unit 460 predicts a movement locus of the transport robots 1A and 1B, based on the map information and the route information received from the route generating unit 440. Specifically, the prediction unit 460 determines whether or not there is a possibility that the transport robots 1A and 1B and the transport object 2 collide with the obstruction 7 existing in the movement region AR1, based on the movement locus when the transport robots 1A and 1B selected as the moving bodies move along the route generated by the route generating unit 440.

Subsequently, when it is determined that the transport robots 1A and 1B and the transport object 2 collide with the obstruction 7 existing in the movement region AR1 in the prediction processing, the route generating unit 440 generates a new route of the transport robots 1A and 1B in Step S50. For example, the route generating unit 440 performs processing of changing the range of the region specified as the second region 7B, excluding a route generated before the prediction by the prediction unit 460, shifting each of the grids indicating the route that may cause collision with the obstruction 7 as predicted by the prediction unit 460 to its adjacent square, or the like, and thereby generates a new route on which the second region 7B can be avoided. The route information related to the new route generated by the route generating unit 440 is transmitted to the prediction unit 460.

Note that, when it is determined that the transport robots 1A and 1B and the transport object 2 collide with the obstruction 7 existing in the movement region AR1 and a new route on which the second region 7B can be avoided fails to be generated in the prediction processing, it may be reported that there is a problem in transport of the transport object 2 by the transport robots 1A and 1B (for example, information related to an unavoidable obstruction 7 existing in the movement region AR1 or the like). Note that, when the prediction unit 460 does not determine that the transport robots 1A and 1B and the transport object 2 collide with the obstruction 7 existing in the movement region AR1, Step S50 may be omitted.

Subsequently, in Step S51, the route generating unit 440 transmits the route information related to the route to the map information storage unit 420 and the moving body control unit 450. When an object such as the obstruction 7 exists in the movement region AR1, the route information transmitted to the moving body control unit 450 includes information related to the avoidance route on which it is determined that the transport robots 1A and 1B and the transport object 2 and the obstruction 7 do not collide with each other in the prediction processing of Step S49.

When the moving body control unit 450 receives the route information, in Step S52, the moving body control unit 450 generates control information for controlling the transport robots 1A and 1B. In this case, regarding the control information generated by the moving body control unit 450, the control information related to the transport robot 1A is first generated, and then the same control information as the control information related to the transport robot 1A is generated as the control information related to the transport robot 1B

Subsequently, in Step S53, the moving body control unit 450 transmits the control information generated in Step S52 to each of the transport robots 1A and 1B. The transport robots 1A and 1B move through the movement region AR1, based on the control information received from the system control apparatus 4.

As described above, in the fourth example embodiment of the present invention, the avoidance route on which the obstruction 7 existing in the movement region AR1 can be avoided is generated, when the route on which the transport robots 1A and 1B move in the movement region AR1 of the transport robots 1A and 1B is generated. With this configuration, the transport robots 1A and 1B can be prevented from coming too close to the obstruction 7, and therefore safety and efficiency in transport operation can be enhanced.

In the fourth example embodiment, the route is generated so that the number of times the transport robots 1A and 1B change the moving direction is reduced. Therefore, the transport object 2 can be less affected by vibration, which can lead to reduction in damage, breakdown, and the like of the transport object 2.

Moreover, the fourth example embodiment is an example embodiment in which the transport object 2 is cooperatively transported by the transport robot 1A and the transport robot 1B. In the cooperative transport, the route is generated such that the number of times of changing the moving direction is reduced, which can exert an effect of allowing the transport robot 1B as the succeeding moving body that moves afterwards to easily follow movement of the transport robot 1A as the leading moving body that moves foremost.

In the fourth example embodiment, in the prediction processing, when the transport robots 1A and 1B move on the route generated by the route generating unit 440, whether the transport robots 1A and 1B collide with the obstruction 7 is determined. When there is a possibility of collision with the obstruction 7 as a result of the prediction processing, a new route is generated, and therefore safety and efficiency of transport operation by the transport robots 1A and 1B can be further enhanced.

### 6. EXAMPLE ALTERATION OF FOURTH EXAMPLE EMBODIMENT

In the transport system 1000C, when the transport robot 1A performs independent transport, processing similar to the processing described with reference to FIG. 22, 23, FIG. 26, and FIG. 27 may be performed. For example, when the transport robot 1A pulls and transports the transport object 2, the number of times the transport robot 1A changes the moving direction is reduced, and therefore the transport object 2 can be less affected by vibration, which can lead to reduction in damage, breakdown, and the like of the transport object 2.

### 7. OTHER EXAMPLE EMBODIMENTS

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram or flowchart. For example, the steps in the processing may be executed in an order different from that described in the corresponding sequence diagram or flowchart, or may be executed in parallel. Some of the steps in the processing may be deleted, or more steps may be added to the processing.

An apparatus including the constituent elements (for example, elements corresponding to the route generating unit 440 and the moving body control unit 450) of the system control apparatus 4 described in the Specification may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### (Supplementary Note 1)

A movement control system comprising:
at least one moving body;
a sensor configured to transmit movement region information related to a movement region of the moving body;
a route generating unit configured to generate a route for the moving body to move through the movement region, based on the movement region information received via a network; and
a moving body control unit configured to control movement of the moving body, based on the route, wherein
the route generating unit is configured to generate an avoidance route for avoiding a second region including a first region representing a position of an object existing in the movement region and a surrounding region at the first region, and
the moving body control unit is configured to control the moving body based on the avoidance route.

### (Supplementary Note 2)

The movement control system according to supplementary note 1, wherein
the moving body is configured to transport a transport object,
the movement control system further comprises a prediction unit configured to predict a movement locus when the moving body transports the transport object while moving on the avoidance route, and
the route generating unit is configured to generate a new avoidance route on which the second region can be avoided, based on the movement locus predicted by the prediction unit.

### (Supplementary Note 3)

The movement control system according to supplementary note 1 or 2, wherein
the moving body comprises a plurality of moving bodies configured to execute cooperative transport, in which the plurality of moving bodies transport the transport object in cooperation with each other, and
the route generating unit is configured to generate, as the route, a cooperative transport route on which the plurality of moving bodies transport the transport object by means of the cooperative transport.

### (Supplementary Note 4)

The movement control system according to any one of supplementary notes 1 to 3, wherein
the movement region information comprises transport object information related to the transport object transported by the moving body, and
the route generating unit is configured to specify the second region, based on the transport object information.

### (Supplementary Note 5)

The movement control system according to any one of supplementary notes 1 to 4, wherein
the movement region comprises a path in which the moving body moves, and
the route generating unit is configured to specify the second region by extending the first region along a direction in which the path extends.

### (Supplementary Note 6)

The movement control system according to any one of supplementary notes 1 to 5, wherein
the route generating unit is configured to generate a route point group indicating a first route for avoiding the second region, based on the movement region information and select a plurality of route points out of the route point group, to thereby generate the avoidance route.

### (Supplementary Note 7)

The movement control system according to any one of supplementary notes 1 to 6, further comprising
an input apparatus configured to perform an operation input of setting a movement starting point and a movement end point of the moving body in the movement region, wherein
the route generating unit is configured to generate the route comprising the movement starting point and the movement end point.

### (Supplementary Note 8)

The movement control system according to supplementary note 2, wherein
the route generating unit is configured to, when the route generating unit fails to generate the route on which the second region can be avoided, based on the movement locus predicted by the prediction unit, report that there is a problem in transport of the object by the moving body.

### (Supplementary Note 9)

A movement control apparatus comprising:
a route generating unit configured to generate, based on movement region information related to a movement region of at least one moving body received from a sensor via a network, a route for the moving body to move through the movement region; and
a moving body control unit configured to control movement of the moving body, based on the route, wherein
the route generating unit is configured to generate an avoidance route for avoiding a second region including a first region representing a position of an object existing in the movement region and a surrounding region at the first region, and
the moving body control unit is configured to control the moving body based on the avoidance route.

### (Supplementary Note 10)

The movement control apparatus according to supplementary note 9, wherein
the moving body is configured to transport a transport object,
the movement control apparatus further comprises a prediction unit configured to predict a movement locus when the moving body transports the transport object while moving on the avoidance route, and
the route generating unit is configured to generate a new avoidance route, based on the movement locus predicted by the prediction unit.

### (Supplementary Note 11)

The movement control apparatus according to supplementary note 9 or 10, wherein
the moving body comprises a plurality of moving bodies configured to execute cooperative transport, in which the plurality of moving bodies transport the transport object in cooperation with each other, and
the route generating unit is configured to generate, as the route, a cooperative transport route on which the plurality of moving bodies transport the transport object by the cooperative transport.

### (Supplementary Note 12)

The movement control apparatus according to any one of supplementary notes 9 to 11, wherein
the movement region information comprises transport object information related to the transport object transported by the moving body, and
the route generating unit is configured to specify the second region, based on the transport object information.

### (Supplementary Note 13)

The movement control apparatus according to any one of supplementary notes 9 to 12, wherein
the movement region comprises a path in which the moving body moves, and
the route generating unit is configured to specify the second region by extending the first region along a direction in which the path extends.

### (Supplementary Note 14)

The movement control apparatus according to any one of supplementary notes 9 to 13, wherein
the route generating unit is configured to generate a route point group indicating a first route for avoiding the second region, based on the movement region information and select a plurality of route points out of the route point group, to thereby generate the avoidance route.

### (Supplementary Note 15)

The movement control apparatus according to supplementary note 10, wherein
the route generating unit is configured to, when the route generating unit fails to generate the route on which the second region can be avoided, based on the movement locus predicted by the prediction unit, report that there is a problem in transport of the object by the moving body.

### (Supplementary Note 16)

A movement control method comprising:
transmitting movement region information related to a movement region of at least one moving body;
generating a route for the moving body to move through the movement region, based on the movement region information received via a network; and
controlling movement of the moving body, based on the route, wherein
in generating the route, an avoidance route for avoiding a second region including a first region representing a position of an object existing in the movement region and a surrounding region at the first region is generated, and
in controlling the movement of the moving body, the moving body is controlled based on the avoidance route.

### (Supplementary Note 17)

The movement control method according to supplementary note 16, wherein
the moving body is configured to transport a transport object,
the movement control method further comprises predicting movement results when the moving body transports the transport object while moving on the avoidance route, and
in generating the route, a new avoidance route is generated, based on the movement results predicted by a prediction unit configured to predict the movement results.

### (Supplementary Note 18)

The movement control method according to supplementary note 16 or 17, wherein
the moving body comprises a plurality of moving bodies configured to execute cooperative transport, in which the plurality of moving bodies transport the transport object in cooperation with each other, and
in generating the route, a cooperative transport route on which the plurality of moving bodies transport the transport object by the cooperative transport is generated.

### (Supplementary Note 19)

The movement control method according to any one of supplementary notes 16 to 18, wherein
the movement region information comprises transport object information related to the transport object transported by the moving body, and
in generating the route, the second region is specified, based on the transport object information.

### (Supplementary Note 20)

The movement control method according to any one of supplementary notes 16 to 19, wherein
the movement region comprises a path in which the moving body moves, and
in generating the route, the second region is specified by extending the first region along a direction in which the path extends.

### (Supplementary Note 21)

The movement control method according to any one of supplementary notes 16 to 20, wherein
in generating the route, a route point group indicating a first route for avoiding the second region is generated based on the movement region information, a plurality of route points are selected out of the route point group, and the avoidance route is thereby generated.

### (Supplementary Note 22)

The movement control method according to any one of supplementary notes 16 to 21, wherein
in generating the route, the route comprising a movement starting point and a movement end point input from an input apparatus configured to perform an operation input of setting the movement starting point and the movement end point of the moving body in the movement region is generated.

### (Supplementary Note 23)

The movement control method according to supplementary note 17, wherein
in generating the route, when the route on which the second region can be avoided fails to be generated based on the movement locus predicted by the prediction unit, that there is a problem in transport of the object by the moving body is reported.

### (Supplementary Note 24)

The movement control system according to any one of supplementary notes 1 to 9, further comprising
a position information generating unit configured to generate position information related to the position of the object, based on the movement region information, wherein
the route generating unit is configured to determine the first region and the second region in the movement region, based on the position information.

### (Supplementary Note 25)

The movement control system according to any one of supplementary notes 2 to 9, further comprising
a map information storage unit configured to store region information related to the first region and the second region, together with map information related to the movement region, wherein
the prediction unit is configured to execute the prediction processing, based on route information related to the avoidance route, the map information, and the region information.

### (Supplementary Note 26)

The movement control system according to any one of supplementary notes 1 to 9, wherein
the route generating unit is configured to acquire moving body information related to the moving body, and determine the second region, based on the moving body information.

### (Supplementary Note 27)

The movement control system according to any one of supplementary notes 1 to 9, wherein
the moving body comprises a plurality of moving bodies,
the movement control system further comprises a moving body selection unit configured to select a moving body to transport the transport object out of the plurality of moving bodies, and
the route generating unit is configured to generate the route of the moving body selected by the moving body selection unit as the moving body to transport the transport object.

### (Supplementary Note 28)

The movement control system according to any one of supplementary notes 1 to 9, wherein
the moving body comprises a plurality of moving bodies, and
the movement control system further comprises a moving body selection unit configured to select a moving body that is capable of moving on the route and is to transport the transport object out of the plurality of moving bodies.

### (Supplementary Note 29)

The movement control system according to supplementary note 27 or 28, wherein
the moving body selection unit is configured to select a leading moving body to transport the transport object foremost, and a succeeding moving body configured to execute cooperative transport of the transport object together with the leading moving body by following the leading moving body, out of the plurality of moving bodies, and
the route generating unit is configured to generate the route of the leading moving body.

### (Supplementary Note 30)

The movement control system according to supplementary note 29, wherein
the leading moving body comprises a first pressurizing unit configured to pressurize the transport object,
the succeeding moving body comprises a second pressurizing unit configured to pressurize the transport object, and
the cooperative transport is executed with the transport object being interposed by the first pressurizing unit and the second pressurizing unit.

### (Supplementary Note 31)

The movement control system according to supplementary note 29 or 30, wherein
the leading moving body comprises
   a leading moving body communication unit configured to communicate with the moving body control unit,
   a leading moving body drive unit, and
   a leading moving body drive control unit configured to control the leading moving body drive unit so that the leading moving body moves on the route,
the succeeding moving body comprises
   a succeeding moving body communication unit configured to communicate with the moving body control unit,
   a state detection unit configured to detect a drive state of the leading moving body,
   a succeeding moving body drive unit, and
   a succeeding moving body drive control unit configured to control the succeeding moving body drive unit, and
the succeeding moving body drive control unit is configured to, when the cooperative transport is executed, control the succeeding moving body drive unit so that the succeeding moving body moves on the route by following the leading moving body, based on the drive state of the leading moving body detected by the state detection unit.

### (Supplementary Note 32)

The movement control system according to supplementary note 31, wherein
the state detection unit is configured to detect a load that the succeeding moving body receives from the transport object, as the drive state of the leading moving body.

### (Supplementary Note 33)

The movement control system according to supplementary note 6, wherein
the route generating unit is configured to select the route point group to avoid the first region and the second region.

### (Supplementary Note 34)

The movement control system according to supplementary note 6 or 33, wherein
the route generating unit is configured to generate the route so that the number of route points comprised in the route is smaller than the number of route points comprised in the first route.

### (Supplementary Note 35)

The movement control system according to any one of supplementary notes 6, 33, and 34, wherein
the route generating unit is configured to generate the route so that the number of changes in a moving direction of the moving body when the route is moved is smaller than the number of changes in the moving direction of the moving body when the first route is moved.

### INDUSTRIAL APPLICABILITY

A movement control system, a movement control apparatus, and a movement control method for enhancing safety and efficiency of transport operation can be provided.

### REFERENCE SIGNS LIST

1, 1A, 1B, 1C Transport Robot
2 Transport Object
2A Burden
3 Sensor
4 System Control Apparatus
5 Access Point (AP)
6 Network
7 Obstruction
7A First Region
7B Second Region
10 Main Body
11 Frame
12, 13 Drive Unit
14, 15 Shaft
16 Control Unit
17 Communication Unit
20,21 Wheel
22 Caster
23 Load Sensor
24 Angle Sensor
30 Contact Part
31,32 Plate Member
33 Friction Part
34, 35, 36, 37 Elastic Member
40 Pivoting Mechanism
41 Arm
42 Shaft Part
43 Arm
47 Stay
50 Restoration Mechanism
51 Oscillation Member
51c, 53 Pin Part
54 Elastic Member
60 Guide Mechanism
61 Guide Member
61A Guide Surface
70 Base
71, 72, 73, 74 Caster
81 Axle
110 Central Processing Unit (CPU)
120 Read Only Memory (ROM)
130 Random Access Memory (RAM)
140 Storage Medium
150 Interface (I/F)
170 Input Unit
180 Display Unit
190 Bus
400 Controller
401 Network I/F
410 Position Information Generating Unit
420 Map Information Storage Unit
430 Moving Body Selection Unit
440, 440D Route Generating Unit
450, 450D Moving Body Control Unit
460 Prediction Unit
1000, 1000A, 1000B, 1000C Transport System
AR1 Movement Region
PS Starting Point
PG End Point

What is claimed is:

1. A movement control system comprising:
at least one moving body;
a sensor configured to transmit movement region information related to a movement region of the moving body;
at least one memory storing instructions, and
at least one processor configured to execute the instructions to:
generate a route for the moving body to move through the movement region, based on the movement region information received via a network; and
control movement of the moving body, based on the route, wherein
the at least processor is further configured to execute the instructions to:
generate an avoidance route for avoiding a second region including a first region representing a position of an object existing in the movement region and a surrounding region at the first region, and
control the moving body based on the avoidance route.

2. The movement control system according to claim 1, wherein
the moving body is configured to transport a transport object,
the at least processor is further configured to execute the instructions to:
predict a movement locus when the moving body transports the transport object while moving on the avoidance route, and
generate a new avoidance route on which the second region can be avoided, based on predicted the movement locus.

3. The movement control system according to claim 1, wherein
the moving body comprises a plurality of moving bodies configured to execute cooperative transport, in which the plurality of moving bodies transport the transport object in cooperation with each other, and
the at least processor is further configured to execute the instructions to generate, as the route, a cooperative transport route on which the plurality of moving bodies transport the transport object by the cooperative transport.

4. The movement control system according to claim 1, wherein
the movement region information comprises transport object information related to the transport object transported by the moving body, and
the at least processor is further configured to execute the instructions to specify the second region, based on the transport object information.

5. The movement control system according to claim 1, wherein
the movement region comprises a path in which the moving body moves, and
the at least processor is further configured to execute the instructions to specify the second region by extending the first region along a direction in which the path extends.

6. The movement control system according to claim 1, wherein
the at least processor is further configured to execute the instructions to generate a route point group indicating a first route for avoiding the second region, based on the movement region information and select a plurality of route points out of the route point group, to thereby generate the avoidance route.

7. The movement control system according to claim 1, further comprising
an input apparatus configured to perform an operation input of setting a movement starting point and a movement end point of the moving body in the movement region, wherein
the at least processor is further configured to execute the instructions to generate the route comprising the movement starting point and the movement end point.

8. A movement control apparatus comprising:
a memory storing instructions; and
one or more processors configured to execute the instructions to:
generate, based on movement region information related to a movement region of at least one moving body received from a sensor via a network, a route for the moving body to move through the movement region; and
control movement of the moving body, based on the route, wherein
the one or more processors are configured to execute the instructions to:
generate an avoidance route for avoiding a second region including a first region representing a position of an object existing in the movement region and a surrounding region at the first region, and
control the moving body based on the avoidance route.

9. The movement control apparatus according to claim 8, wherein
the moving body is configured to transport a transport object,
the one or more processors are configured to execute the instructions to:
predict a movement locus when the moving body transports the transport object while moving on the avoidance route, and
generate a new avoidance route on which the second region can be avoided, based on the predicted movement locus.

10. The movement control apparatus according to claim 8, wherein
the moving body comprises a plurality of moving bodies configured to execute cooperative transport, in which the plurality of moving bodies transport the transport object in cooperation with each other, and
the one or more processors are configured to execute the instructions to generate, as the route, a cooperative transport route on which the plurality of moving bodies transport the transport object by the cooperative transport.

11. The movement control apparatus according to claim 8, wherein
the movement region information comprises transport object information related to the transport object transported by the moving body, and
the one or more processors are configured to execute the instructions to specify the second region, based on the transport object information.

12. The movement control apparatus according to claim 8, wherein
the movement region comprises a path in which the moving body moves, and
the one or more processors are configured to execute the instructions to specify the second region by extending the first region along a direction in which the path extends.

13. The movement control apparatus according to claim 8, wherein
the one or more processors are configured to execute the instructions to generate a route point group indicating a first route for avoiding the second region, based on the movement region information and select a plurality of route points out of the route point group, to thereby generate the avoidance route.

14. A movement control method comprising:
transmitting movement region information related to a movement region of at least one moving body;
generating a route for the moving body to move through the movement region, based on the movement region information received via a network; and
controlling movement of the moving body, based on the route, wherein
in generating the route, an avoidance route for avoiding a second region including a first region representing a position of an object existing in the movement region and a surrounding region at the first region is generated, and
in controlling the movement of the moving body, the moving body is controlled based on the avoidance route.

15. The movement control method according to claim 14, wherein
the moving body is configured to transport a transport object,
the movement control method further comprises predicting a movement locus when the moving body transports the transport object while moving on the avoidance route, and
in generating the route, a new avoidance route on which the second region can be avoided is generated, based on the predicted movement locus.

16. The movement control method according to claim 14, wherein
the moving body comprises a plurality of moving bodies configured to execute cooperative transport, in which the plurality of moving bodies transport the transport object in cooperation with each other, and
in generating the route, a cooperative transport route on which the plurality of moving bodies transport the transport object by the cooperative transport is generated.

17. The movement control method according to claim 14, wherein
the movement region information comprises transport object information related to the transport object transported by the moving body, and
in generating the route, the second region is specified based on the transport object information.

18. The movement control method according to claim 14, wherein
the movement region comprises a path in which the moving body moves, and
in generating the route, the second region is specified by extending the first region along a direction in which the path extends.

19. The movement control method according to claim 14, wherein
in generating the route, a route point group indicating a first route for avoiding the second region is generated based on the movement region information, a plurality of route points are selected out of the route point group, and the avoidance route is thereby generated.

20. The movement control method according to claim 14, wherein
in generating the route, the route comprising a movement starting point and a movement end point input from an input apparatus configured to perform an operation input of setting the movement starting point and the movement end point of the moving body in the movement region is generated.
